(19) United States
(12) Patent Application Publication
(10) Pub. No.: US 2019/0243336 A1
(43) Pub. Date: Aug. 8, 2019

(54) GEOMETRIC MODELLING FOR FACILITATING SIMULATION FOR MANUFACTURING OPERATIONS

(71) Applicant: THE UNIVERSITY OF BRITISH COLUMBIA, Vancouver (CA)

(72) Inventors: Jimin JOY, Vancouver (CA); Hsi-Yung FENG, Vancouver (CA); Jack Szu-Shen CHEN, Richmond (CA)

(21) Appl. No.: 16/335,475

(22) PCT Filed: Sep. 22, 2017
(86) PCT No.: PCT/CA2017/051114

§ 371 Date: Mar. 21, 2019

Related U.S. Application Data
(60) Provisional application No. 62/398,339, filed on Sep. 22, 2016.

(51) Int. Cl. G05B 19/4097

(52) U.S. Cl. CPC G05B 19/4097; G05B 2219/35134

(57) ABSTRACT

A computer-implemented method of geometric modeling to facilitate simulation for manufacturing operations is provided. The method involves causing at least one processor to receive signals representing a workpiece, and derive a workpiece model representation of the workpiece. Deriving the workpiece model involves identifying volumes that each include a surface of the workpiece, generating a plurality of volume elements for inclusion in the workpiece model, each volume element associated with a respective identified volume and representing presence of the surface of the workpiece in the respective identified volume. Deriving also involves determining at least one location on a linear boundary of a volume where the surface of the workpiece intersects the linear boundary, and, in response to the determining, generating at least one boundary surface element associated with the volume element for inclusion in the workpiece model. Other methods, systems, and computer-readable media are also disclosed.

### RELATED APPLICATION

This application claims the benefit of U.S. Provisional Application No. 62/398,339 entitled “FRAME-SLICED VOXEL REPRESENTATION: AN ACCURATE AND MEMORY-EFFICIENT MODELING METHOD FOR WORKPIECE GEOMETRY IN MACHINING SIMULATION”, filed on Sep. 22, 2016, which is hereby incorporated by reference herein in its entirety.

### BACKGROUND

### 1. Field

Embodiments of this invention relate to geometric modeling and more particularly to geometric modeling for facilitating simulation for manufacturing operations.

### 2. Description of Related Art

Computers and computer systems configured to provide geometric modeling may be used as part of process planning and verification in modern manufacturing practice. A computer may be configured to provide geometric modeling to facilitate verification and/or creation of important inputs for mechanistic simulation, such as, for example, for machining simulation. However, industrial machining cases are ever increasing in complexity and demand computers systems that are configured to provide faster geometric modeling while maintaining an acceptable level of accuracy. Various known computers and computer systems for providing geometric modeling may be unable to achieve sufficient accuracy, efficiency and robustness, especially in view of the increasing complexity of modern machining.

### SUMMARY

In accordance with one embodiment, there is provided a computer-implemented method of geometric modeling to facilitate simulation for manufacturing operations, the method involving causing at least one processor to receive signals representing a workpiece in a workspace volume, and causing the at least one processor to derive, based on the signals representing the workpiece, a workpiece model representation of the workpiece. The deriving involves: causing the at least one processor to identify a plurality of volumes in the workspace volume that each include a surface of the workpiece, causing the at least one processor to generate a plurality of volume elements for inclusion in the workpiece model, each volume element associated with a respective identified volume in the workspace volume and representing presence of the surface of the workpiece in the respective identified volume, for each of the volume elements: for at least one linear boundary of a set of linear boundaries of the volume associated with the volume element: causing the at least one processor to determine at least one location on the linear boundary where the surface of the workpiece intersects the linear boundary, and, in response to the determining, causing the at least one processor to generate at least one boundary surface element associated with the volume element for inclusion in the workpiece model, the at least one boundary surface element associated with the linear boundary and representing at least one location at which the surface of the workpiece model intersects the linear boundary. For at least one of the volume elements: for at least one linear boundary of a set of linear boundaries of the volume associated with the volume element: causing the at least one processor to determine the at least one location on the linear boundary where the surface of the workpiece intersects the linear boundary involves causing the at least one processor to determine first and second different locations on the linear boundary where the surface of the workpiece intersects the linear boundary, and causing the at least one processor to generate the at least one boundary surface element associated with the volume element involves causing the at least one processor to generate first and second boundary surface elements that represent the first and second different locations on the linear boundary where the surface of the workpiece intersects the linear boundary.

In accordance with another embodiment, there is provided a computer-implemented method of geometric simulation for manufacturing operations, the method involving causing the at least one processor to receive signals representing a workpiece to be machined in a workspace volume, causing the at least one processor to derive, based on the signals representing the workpiece, a workpiece model representing the workpiece, the workpiece model including: a plurality of first-level volume elements, each representing presence of at least a portion of the workpiece in a respective first-level volume within the workspace volume, and a plurality of sets of second-level volume elements, each set of second-level volume elements: associated with a respective one of the first-level volumes, and including one or more second-level volume elements, each representing presence of at least a portion of the workpiece in a respective second-level volume within the one of the first-level volumes, wherein the second-level volume is smaller than the first-level volume. The method also involves causing the at least one processor to receive signals representing at least one tool volume to be applied to the workpiece, the at least one tool volume having at least one tool envelope, causing the at least one processor to update the workpiece model based on the at least one tool volume, the updating the workpiece model involving: causing the at least one processor to determine that at least one of the first-level volume elements is a potential partially removed first-level volume element that represents presence of at least a portion of the workpiece in a first-level volume that may be partially within the at least one tool volume, causing the at least one processor to determine that at least one set of the second-level volume elements is a potential partially removed set of second-level volume elements that is associated with second-level volumes contained within a first-level volume associated with a potential partially removed first-level volume element, and, in response to determining that at least one set of the second-level volume elements is a potential partially removed set of second-level volume elements, causing the at least one processor to update the potential partially removed set of second-level volume elements.

In accordance with another embodiment, there is provided a computer-implemented system for geometric modeling to facilitate simulation for manufacturing operations, the system including at least one processor configured to perform any of the above methods.

In accordance with another embodiment, there is provided a computer readable medium having stored thereon codes which when executed by at least one processor cause the at least one processor to perform any of the above methods.

In accordance with another embodiment, there is provided a system for geometric modeling to facilitate simulation for manufacturing operations, the system including means for receiving signals representing a workpiece in a workspace volume, and means for deriving, based on the signals representing the workpiece, a workpiece model representation of the workpiece, the means for deriving including: means for identifying a plurality of volumes in the workspace volume that each include a surface of the workpiece, means for generating a plurality of volume elements for inclusion in the workpiece model, each volume element associated with a respective identified volume in the workspace volume and representing presence of the surface of the workpiece in the respective identified volume, for each of the volume elements: for at least one linear boundary of a set of linear boundaries of the volume associated with the volume element: means for determining at least one location on the linear boundary where the surface of the workpiece intersects the linear boundary, and means for, in response to the determining, generating at least one boundary surface element associated with the volume element for inclusion in the workpiece model, the at least one boundary surface element associated with the linear boundary and representing at least one location at which the surface of the workpiece model intersects the linear boundary. For at least one of the volume elements: for at least one linear boundary of a set of linear boundaries of the volume associated with the volume element: the means for determining the at least one location on the linear boundary where the surface of the workpiece intersects the linear boundary includes means for determining first and second different locations on the linear boundary where the surface of the workpiece intersects the linear boundary, and the means for generating the at least one boundary surface element associated with the volume element includes means for generating first and second boundary surface elements that represent the first and second different locations on the linear boundary where the surface of the workpiece intersects the linear boundary.

In accordance with another embodiment, there is provided a system for geometric simulation for manufacturing operations, the system including means for receiving signals representing a workpiece to be machined in a workspace volume, means for deriving, based on the signals representing the workpiece, a workpiece model representing the workpiece, the workpiece model including: a plurality of first-level volume elements, each representing presence of at least a portion of the workpiece in a respective first-level volume within the workspace volume, and a plurality of sets of second-level volume elements, each set of second-level volume elements: associated with a respective one of the first-level volumes, and including one or more second-level volume elements, each representing presence of at least a portion of the workpiece in a respective second-level volume within the one of the first-level volumes, wherein the second-level volume is smaller than the first-level volume. The system also includes means for receiving signals representing at least one tool volume to be applied to the workpiece, the at least one tool volume having at least one tool envelope, and means for updating the workpiece model based on the at least one tool volume. The means for updating the workpiece model includes means for determining that at least one of the first-level volume elements is a potential partially removed first-level volume element that represents presence of at least a portion of the workpiece in a first-level volume that may be partially within the at least one tool volume, means for determining that at least one set of the second-level volume elements is a potential partially removed set of second-level volume elements that is associated with second-level volumes contained within a first-level volume associated with a potential partially removed first-level volume element, and means for, in response to determining that at least one set of the second-level volume elements is a potential partially removed set of second-level volume elements, updating the potential partially removed set of second-level volume elements.

Other aspects and features of embodiments of the invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a manufacturing system in accordance with various embodiments of the invention;

FIG. 2 is a smoothed visual representation of a triangle mesh representation of a workpiece included in the system shown in FIG. 1, in accordance with various embodiments of the invention;

FIG. 3 is a representation of a model including a plurality of volume elements for representing the workpiece included in the system shown in FIG. 1, in accordance with various embodiments of the invention;

FIG. 4 is a representation of a set of second-level volumes used in the system shown in FIG. 1, in accordance with various embodiments

FIG. 5 is a representation of exemplary boundary surface points that may be used in the system shown in FIG. 1, in accordance with various embodiments of the invention;

FIG. 6 is a schematic view of a simulator of the system of FIG. 1 including a processor circuit in accordance with various embodiments of the invention;

FIG. 7 is a flowchart depicting blocks of code for directing the simulator of the system of FIG. 1 to perform simulator functions, in accordance with various embodiments of the invention;

FIG. 8 is a flowchart depicting blocks of code that may be included in a block of the flowchart of FIG. 7, in accordance with various embodiments of the invention;

FIG. 9 is a representation showing how coordinates may be determined for a volume in the system shown in FIG. 1, in accordance with various embodiments of the invention;

FIG. 10 is a top view representation of a layer of identified second-level volumes that may be used in a model in the system shown in FIG. 1;

FIG. 11 is a flowchart depicting blocks of code that may be included in a block of the flowchart of FIG. 7 in accordance with various embodiments of the invention;

FIG. 12 is a representation of an exemplary bit-array that may be used in a model in the system shown in FIG. 1;

FIG. 13 is a representation of an exemplary bit-array that may be used in a model in the system shown in FIG. 1;

FIG. 14 is a top view representation of a layer of first-level volumes that may be used in a model in the system shown in FIG. 1 in accordance with various embodiments of the invention;

FIG. 15 is a representation of an exemplary bit-array that may be used in a model in the system shown in FIG. 1;

FIG. 16 is a top view cross section of a representation of a model that may be used in the system shown in FIG. 1 in accordance with various embodiments of the invention;

FIG. 17 is a flowchart depicting blocks of code that may be included in a block of the flowchart of FIG. 7 in accordance with various embodiments of the invention;

FIG. 18 is a representation of a volume that may be used in the system shown in FIG. 1 with vertices labeled in accordance with various embodiments of the invention;

FIG. 19 is a representation of boundary surface points that may be used in a model in the system shown in FIG. 1 in accordance with various embodiments of the invention;

FIG. 20 is a representation of boundary surface points that may be used in a model in the system shown in FIG. 1 in accordance with various embodiments of the invention;

FIG. 21 is a representation of an exemplary boundary surface elements record that may be used in a model in the system shown in FIG. 1;

FIG. 22 is a representation of exemplary boundary surface points that may be used in a model in the system shown in FIG. 1;

FIG. 23 is a representation of exemplary boundary surface point simplification that may be used in a model in the system shown in FIG. 1;

FIG. 24 is a top view cross section of a representation of a model that may be used in the system shown in FIG. 1 in accordance with various embodiments of the invention;

FIG. 25 is a top view representation of tool volumes that may be used in the system shown in FIG. 1 in accordance with various embodiments of the invention;

FIG. 26 is a flowchart depicting blocks of code that may be included in a block of the flowchart of FIG. 7 in accordance with various embodiments of the invention;

FIG. 27 is a top view cross section of a representation of a model that may be used in the system shown in FIG. 1 in accordance with various embodiments of the invention;

FIG. 28 is a flowchart depicting blocks of code that may be included in a block of the flowchart of FIG. 26 in accordance with various embodiments of the invention;

FIG. 29 is a top view cross section of a representation of a model that may be used in the system shown in FIG. 1 in accordance with various embodiments of the invention;

FIG. 30 is a flowchart depicting blocks of code that may be included in a block of the flowchart of FIG. 26 in accordance with various embodiments of the invention;

FIG. 31 is a representation of an exemplary first-level volume tooled surface record that may be used in a model in the system shown in FIG. 1;

FIG. 32 is a flowchart depicting blocks of code that may be included in a block of the flowchart of FIG. 26 in accordance with various embodiments of the invention;

FIG. 33 is a flowchart depicting blocks of code that may be included in a block of the flowchart of FIG. 26 in accordance with various embodiments of the invention;

FIG. 34 is a representation of an exemplary second-level volume tooled surface record that may be used in a model in the system shown in FIG. 1;

FIG. 35 is a flowchart depicting blocks of code that may be included in a block of the flowchart of FIG. 26 in accordance with various embodiments of the invention;

FIG. 36 is a top view cross section of a representation of a model that may be used in the system shown in FIG. 1 in accordance with various embodiments of the invention;

FIG. 37 is a flowchart depicting blocks of code for directing the simulator of the system of FIG. 1 to perform updated workpiece model conversion and representation functions in accordance with various embodiments of the invention; and

FIG. 38 is a representation of a display that may be presented by a display of a user interface system included in the system shown in FIG. 1 in accordance with various embodiments of the invention.

### DETAILED DESCRIPTION

As discussed above, some known computer-implemented geometric modeling processes are unable to achieve sufficient accuracy, efficiency and robustness, especially in view of the increasing complexity of industrial machining.

Various embodiments disclosed herein may provide a computer-implemented geometric modeling system and/or method that may achieve the accuracy, efficiency, and/or robustness required for modern complex industrial machining. For example, in various embodiments disclosed herein, there is provided a computer-implemented enhanced voxel representation format for geometric modeling, which may facilitate modeling of a machined workpiece geometry in general milling operations, for example.

In some embodiments, one or more computers may be configured to provide the modeling format using volume elements or voxels with associated boundary surface elements for representing portions of or sliced volume elements. In some embodiments, partial volume elements or voxels may enable approximation of a workpiece surface to achieve sub-voxel detail.

In some embodiments, one or more computers configured to provide the modeling format may facilitate an efficient update process that can be employed to compute machined part geometry from an initial workpiece model and set of tool paths, for example.

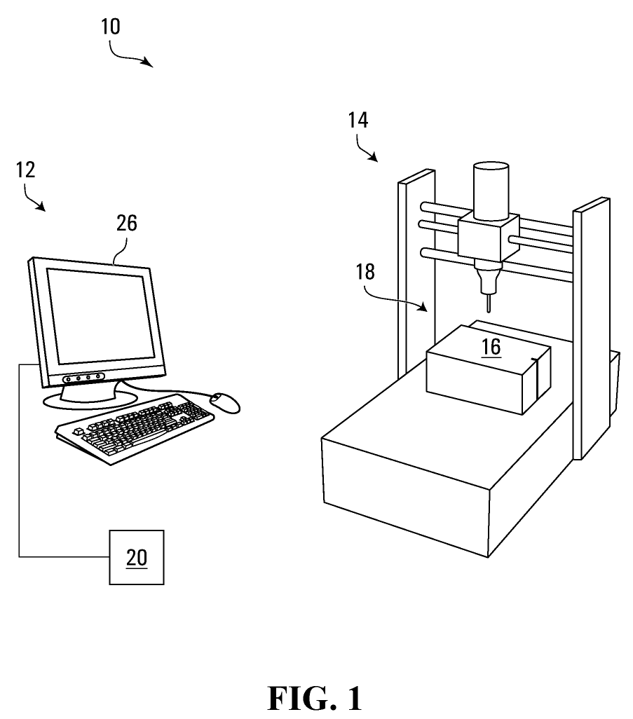

Referring to FIG. 1, according to one embodiment of the invention, there is provided a manufacturing system 10. In the embodiment shown, the manufacturing system 10 includes a simulation system 12 for facilitating geometric simulation of manufacturing operations and a computer-controlled milling machine 14 for machining a workpiece 16 in a workspace volume 18 of the machine. While a single machine 14 and a single workpiece 16 is shown in FIG. 1 for ease of reference, in various embodiments the system 10 may include a plurality of the devices shown in FIG. 1. For example, the system 10 may include numerous milling machines for machining workpieces, each machine being generally similar to the milling machine 14 and each workpiece being generally similar to the workpiece 16, for example.

Referring to FIG. 1, the simulation system 12 includes a computer-implemented simulator 20 in communication with a user interface system 26 which includes a display and one or more input devices, such as a keyboard and a pointing device, for example.

A user or users of the simulation system 12 may wish to cut the workpiece 16 using the milling machine 14 into a desired final shape and dimensions, but before proceeding with cutting, the user may wish to verify that the result of the machining will be a final product that matches the user's wishes. Accordingly, the user may use the simulation system 12 to model the workpiece 16 and simulate the machining before proceeding with machining or cutting. In various embodiments, aspects of the simulation system 12 disclosed herein may facilitate accuracy, efficiency and robustness in modeling the workpiece 16 and/or simulating the machining process.

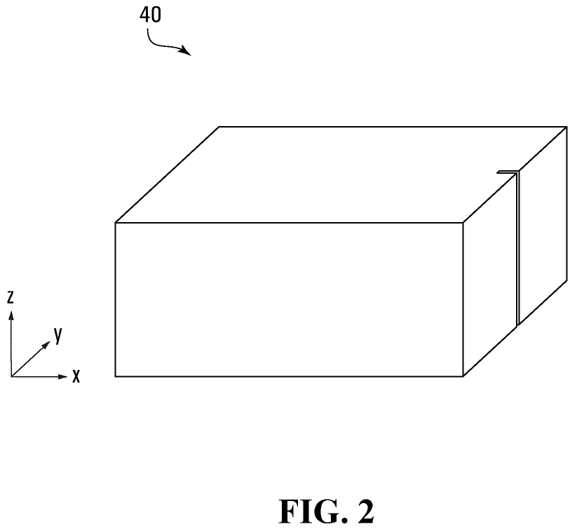

In operation, a user may first generate a representation of the workpiece 16 to be machined, using Computer Aided Design (CAD) and/or Computer Aided Manufacturing (CAM) tools, for example, and cause the representation to be stored in memory in the simulator 20. For example, the representation of the workpiece 16 may be a triangle mesh representation of the workpiece 16 in the workspace volume 18, a smoothed visual representation of which is shown at 40 in FIG. 2. Referring to FIG. 2, the representation 40 of the workpiece 16 shows that the workpiece 16 is a generally rectangular block with a small slit cut in one side. Of course, the representation of the workpiece 16 shown in FIG. 2 and referred to herein is exemplary and workpieces of any other shape may be used in various embodiments.

Referring to FIG. 1, in various embodiments, a user may initiate geometric modeling to facilitate simulation for manufacturing operations by interacting with the user interface system 26. In response to user input, the simulator 20 may retrieve a representation of the workpiece 16, such as a triangle mesh representation, from memory and thus receive signals representing the workpiece 16 in the workspace volume 18.

The simulator 20 may then derive, based on the received signals representing the workpiece 16, a workpiece model representation of the workpiece. In some embodiments, the derived workpiece model may include various elements that coordinate to facilitate accuracy, efficiency and robustness in modeling the workpiece 16 and simulating the machining process.

In some embodiments, the derived workpiece model may include elements used in space partitioning models. In space partitioning, the modelling space is divided into smaller constituent volumes. A model may be represented using many of these constituent volumes of the modelling space. For example, the workpiece model may incorporate space subdivision with a uniform 3-dimensional (3D) grid of cubical volumes, which may be referred to herein as voxels. In some embodiments, each of the volumes may be a volume at a 3D location in the workspace volume 18 and presence of at least a portion of the workpiece in the volume may be represented by values stored as volume elements included in the model and associated with respective volumes in the workspace volume 18. Using these volume elements, an approximate representation of the workpiece can be stored.

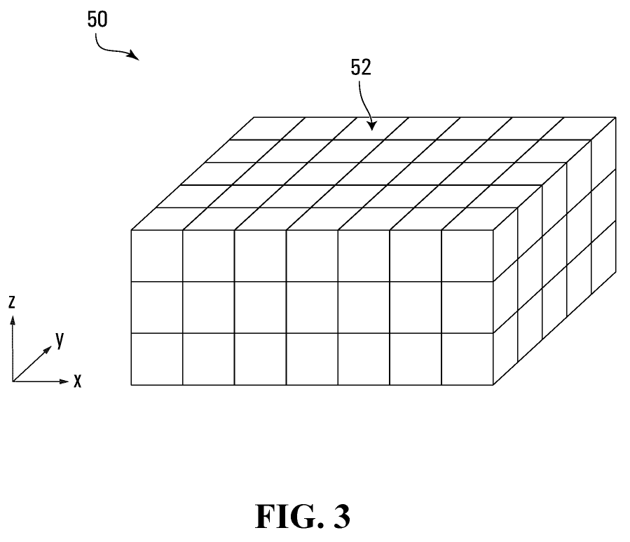

FIG. 3 depicts at 50 a representation of a model including a plurality of volume elements for representing the workpiece 16. The representation 50 shows as visible blocks, volumes corresponding to each volume element in the model that is set to “active” and thus represents presence of the workpiece in the volume. Volumes that do not correspond to any volume element, or correspond to a volumetric element that is not set to “active” are not shown in the representation 50. Notably, in the representation 50 shown in FIG. 3, the slit of the workpiece 16 is not discernible because the slit is smaller than the volumes by which the workspace volume is divided.

In some embodiments, the workpiece model may include more than one type of volume element, with each type associated with a different volume size in the workspace volume 18. For example, the workpiece model may include first-level volume elements and second-level volume elements, where the first-level volume elements are associated with volumes that are larger than the volumes associated with the second-level volume elements.

For example, in some embodiments, in the model represented by the representation 50 shown in FIG. 3, each volume may be a first-level volume and may be associated with a first-level volume element of the model. A model may further include second-level volume elements or fine-level volume elements associated with second-level volumes that are smaller than the first-level volumes and this may provide finer resolution for the model which may be helpful in defining portions of the workpiece where finer detail is required. For example, in some embodiments, each first-level volume may have an edge length that is four times as long as the edge length of a second-level volume and each first-level volume may contain 64 second-level volumes.

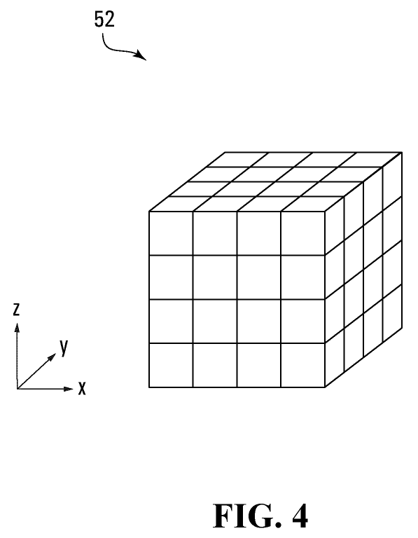

Thus, each of the first-level volumes shown in FIG. 3, which is associated with a first-level volume element, may be separated into 64 different second-level volumes, which may each be associated with a respective second-level volume element that represents presence or absence of at least a portion of the workpiece in the second-level volume. Referring to FIG. 4, first-level volume 52 of FIG. 3 is shown as a set of 64 second-level volumes, which may each be associated with a second-level volume element included in the model having a value that may represent presence or absence of the workpiece in the associated volume.

In various embodiments shown herein, the first-level volumes have an edge length of 4 mm and the second-level volumes have an edge length of 1 mm. However, in various embodiments, different edge lengths may be used. For example, when using the model in machining simulation, first-level volumes may be chosen to have edge length less than a radius of a tool used in the machining.

In view of the foregoing, in various embodiments, where first-level volume elements and second-level volume elements are used to model a workpiece, the workspace volume may be viewed as separated by different overlaying 3D grids, with each 3D grid having a different resolution.

In some embodiments, the workpiece model may include a sparse voxel representation and volume elements may be set to “active” only when the associated volume includes a surface of the workpiece 16, and thus inner portions of the workpiece may be represented by volume elements that are not set to “active”. The volume elements which represent a volume that includes a surface of the workpiece may be referred to herein as “surface volume elements” or “surface voxels”. In some embodiments, using a sparse voxel representation where only the surface volume elements are set to active may reduce storage space used by the model.

In some embodiments, the workpiece model may include a hybrid voxel representation which includes first-level volume elements that are set to active if any portion of the workpiece is in the associated volume and second-level volume elements which are set to active only when an associated second-level volume includes a surface of the workpiece 16. Such a configuration may help facilitate geometric modelling for manufacturing operations, as detailed below.

In various embodiments, the use of different levels of volume elements may facilitate accurate representation of the workpiece by using smaller voxels to represent portions of the workpiece with fine detail, while keeping memory usage down by using larger voxels to represent portions of the workpiece without fine detail, such as, for example, inner portions of the workpiece. In various embodiments, the use of different levels of volume elements may facilitate direct and easier access of second-level or fine-level volume elements without the need to traverse a hierarchical tree such as an octree. Further, in some embodiments, as detailed below, using different levels of volume elements may facilitate efficient geometric simulation for manufacturing operations since volume elements for smaller volumes may not need to be considered when larger volumes which contain the small volumes are known to be removed by a tool.

While the use of more than one level of volume element can be helpful to increase resolution in a workpiece model, in some embodiments, the finest resolution that can be provided by a volume element model alone may be limited due to computer memory and computational load restrictions. Accordingly, in some embodiments, the workpiece model may include boundary surface elements to provide sub-voxel resolution for the model.

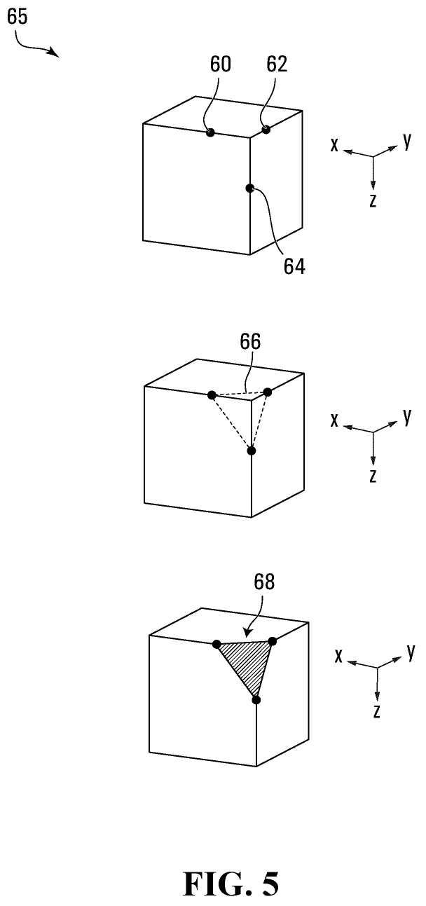

In some embodiments, each boundary surface element may be associated with a second-level volume (e.g. as shown at 65 in FIG. 5) and may represent one or more points (e.g. as shown at 60, 62, and 64 in FIG. 5) from the workpiece surface, taken at an intersection point or frame crossing (FC) point on a boundary or edge-frame of the second-level volume. These points may be referred to herein as boundary surface points or FC points. One or more 3D loops or closed chains (e.g. as shown at 66 in FIG. 5) can be formed from the boundary surface points and a 3D piecewise linear surface (e.g. as shown at 68 in FIG. 5) can then be defined, which is within the volume or surface voxel. This 3D surface may be considered a slice front because it may be seen as slicing the volume into an interior and an exterior part. The frame slice that is interior to the modelled workpiece along with the associated slice front(s) may define a partial volume or voxel which may be referred to herein as a frame-sliced (FS) voxel as it is derived from a sliced frame and all such FS-voxels may act to define a boundary or surface for the workpiece model and together form a connected surface-voxel boundary representation which may be referred to herein as a frame-sliced voxel representation or FSV-rep in short.

In some embodiments, a workpiece may include a surface that crosses a second-level volume boundary more than once. In such embodiments, the model may include first and second boundary surface elements associated with the boundary that represent first and second different locations on the linear boundary where the surface of said workpiece intersects the linear boundary. In various embodiments, the workpiece model being able to represent more than one boundary surface point on a boundary of a volume may facilitate accurate modelling of features that are smaller than the finest volume represented by volume elements of the model.

Accordingly, in various embodiments, with the additional information provided by the boundary surface elements, the workpiece model may facilitate representation of fine detail and/or smooth surfaces that may not be feasible with volume elements alone.

In some embodiments, the simulator 20 may be configured to derive the workpiece model by identifying second-level volumes in the workspace volume that include a surface of the workpiece as surface second-level volumes and generating second-level volume elements for inclusion in the workpiece model, each second-level volume element associated with a respective identified surface second-level volume. In some embodiments, the simulator 20 may be configured to generate the first-level volume elements based on a determination of which first-level volumes in the workspace volume include the identified second-level volumes and thus also include a surface of the workpiece.

In some embodiments, the simulator 20 may generate a set of boundary surface elements for each surface second-level volume element, each boundary surface element associated with a linear boundary of the second-level volume and representing a location at which the surface of the workpiece model intersects the linear boundary. In various embodiments, at least one set of the boundary surface elements may include first and second boundary surface elements that represent first and second different locations on a linear boundary where the surface of the workpiece intersects the linear boundary.

In some embodiments, there may be more than two locations of intersection on a linear boundary from the workpiece surface and a subset of the locations may be selected to represent the more than two locations. For example, in some embodiments, one location may be selected from the more than two locations as a simplified but topologically valid representation of the more than two locations.

In some embodiments, after deriving the workpiece model, a user may wish to simulate manufacturing operations. The user may generate one or more proposed tool paths, using CAD and/or CAM tools, for one or more tools on the milling machine 14 to follow to cause the machine to cut the workpiece 16 into a desired final shape and dimensions. Tool path generation may involve many manual input and parameter settings. The user may cause a representation of the tool paths to be stored in memory in the simulator 20 shown in FIG. 1, for example. In some embodiments, the representation of the one or more tool paths may act as a representation of at least one tool volume, representing one or more volumes through which the tool of the machine 14 will pass and therefore remove material.

The user may interact with the user interface system 26 to initiate simulation of manufacturing operations and the simulator 20 may receive signals representing at least one tool volume to be removed from the workpiece. In various embodiments, the at least one tool volume may have been previously provided to the simulator, for example, by a user as set out above and the simulator 20 may retrieve the at least one tool volume from memory or derive the at least one tool volume from at least one tool path.

The simulator 20 may then update the workpiece model based on the at least one tool volume. The simulator 20 may be configured to determine which of the first level volume elements represents presence of at least a portion of the workpiece in a first-level volume that may be partially within the at least one tool volume and thus could include a new surface that is created by the machining process (referred to herein as a tooled surface). These first-level volume elements may be referred to herein as potential partially removed first-level volume elements and these first-level volumes may be referred to herein as potential partially removed first-level volumes. The simulator 20 may be configured to consider updating only second-level volume elements which are associated with second-level volumes that are within potential partially removed first-level volumes. Thus, in various embodiments, the simulator 20 is configured to determine that a set of second-level volume elements is associated with second-level volumes contained within a potential partially removed first-level volume and in response to said determining, update the set of second-level volume elements.

The simulator 20 may be configured to update the set of second-level volume elements by identifying which of the second-level volumes represent presence of at least a portion of the workpiece in a second-level volume that is partially within the at least one tool volume and thus may include a tooled surface. These second-level volume elements may be referred to herein as partially removed second-level volume elements and these second-level volumes may be referred to herein as partially removed second-level volumes. The simulator 20 may be configured to update the workpiece model to represent presence of a surface of the workpiece in the partially removed second-level volumes.

The simulator 20 may be configured to determine that a set of boundary surface elements is associated with a partially removed second-level volume and to update the set of boundary elements based at least in part on the at least one tool volume.

In various embodiments, the above process for updating the workpiece model may allow the simulator 20 to avoid considering and updating second-level volume elements associated with volumes that could not possibly include a tooled surface. The above process may also facilitate avoidance of considering and updating boundary surface elements associated with volumes that could not possibly include a tooled surface. In various embodiments, this may facilitate fast and efficient geometric simulation for manufacturing operations.

In some embodiments, once the workpiece model has been updated, a user may wish to analyze the updated workpiece model and so the user may wish to export for analysis and/or view the updated workpiece represented by the updated workpiece model. Accordingly, the user may use the user interface system 26 to interact with the simulator 20 to cause the simulator to provide a representation of the updated workpiece model. In some embodiments, the simulator 20 may convert the updated workpiece model into a format that can be displayed and/or produce signals representing the converted updated workpiece model. In some embodiments, the signals representing the converted updated workpiece model may cause a display of the user interface system 26 to display a representation of the converted updated workpiece model.

### Simulator—Processor Circuit

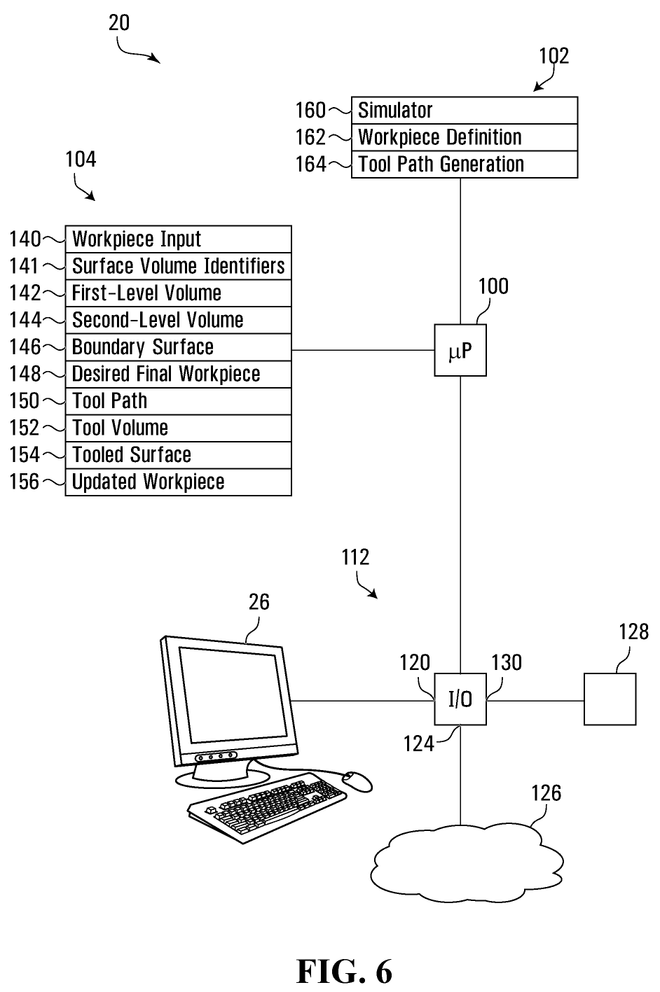

Referring now to FIG. 6, a schematic view of the simulator 20 of the simulation system 12 shown in FIG. 1 according to an embodiment is shown.

Referring to FIG. 6, the simulator 20 includes a processor circuit including a simulator processor 100 and a program memory 102, a storage memory 104, and an input/output (I/O) interface 112, all of which are in communication with the simulator processor 100. In various embodiments, the simulator processor 100 may include one or more processing units, such as for example, a central processing unit (CPU), a graphical processing unit (GPU), and/or a field programmable gate array (FPGA). In some embodiments, any or all of the functionality of the simulator 20 described herein may be implemented using one or more FPGAs.

The I/O interface 112 includes an interface 120 for communicating with the user interface system 26. In some embodiments, the I/O interface 112 may also include an interface 130 for facilitating communication with a removable memory 128 and/or an interface 124 for facilitating networked communication through a network 126 which may be an intranet or the Internet, for example. In some embodiments, any of the interfaces 120, 124, or 130 may facilitate wireless or wired communication.

In some embodiments, the I/O interface 112 may include a network interface device or card with an input/output for connecting to the network 126, through which communications may be conducted with devices connected to the network 126, such as the milling machine 14 shown in FIG. 1, for example.

Referring to FIG. 6, in some embodiments, each of the interfaces may include one or more interfaces and/or some or all of the interfaces included in the I/O interface 112 may be implemented as combined interfaces or a single interface.

In some embodiments, where a device is described herein as receiving or sending information, it may be understood that the device receives signals representing the information via an interface of the device or produces signals representing the information and transmits the signals to the other device via an interface of the device.

Processor-executable program codes for directing the simulator processor 100 to carry out various functions are stored in the program memory 102. Referring to FIG. 6, the program memory 102 includes a block of codes 160 for directing the simulator 20 to perform simulator functions, a block of codes 162 for directing the simulator processor 100 to perform workpiece representation input functions, and a block of codes 164 for directing the simulator processor 100 to perform tool path generation functions. In this specification, it may be stated that certain encoded entities such as applications or modules perform certain functions. Herein, when an application, module or encoded entity is described as taking an action, as part of, for example, a function or a method, it will be understood that at least one processor (e.g. the simulator processor 100) is directed to take the action by way of programmable codes or processor-executable codes or instructions defining or forming part of the application.

The storage memory 104 includes a plurality of storage locations including location 140 for storing input workpiece representation data, location 141 for storing surface volume identification information, location 142 for storing first-level volume information, location 144 for storing second-level volume information, location 146 for storing boundary surface information, location 148 for storing desired final workpiece information, location 150 for storing tool path data, location 152 for storing tool path volume information, location 154 for storing tooled surface information, and location 156 for storing updated workpiece representation data. In various embodiments, the plurality of storage locations may be stored in a database in the storage memory 104.

In various embodiments, the blocks of codes 160, 162 and 164 may be integrated into a single block of codes and/or each of the blocks of code 160, 162 and 164 may include one or more blocks of code stored in one or more separate locations in program memory 102. In various embodiments, any or all of the locations 140, 141, 142, 144, 146, 148, 150, 152, 154, and 156 may be integrated and/or each may include one or more separate locations in the storage memory 104.

In various embodiments, each of the program memory 102 and storage memory 104 may be implemented as one or more storage devices including, for example, random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 102, the storage memory 104, and/or any portion thereof may be included in a device separate from the simulator 20 and in communication with the simulator 20 via the I/O interface 112, for example.

### Modelling and Simulation

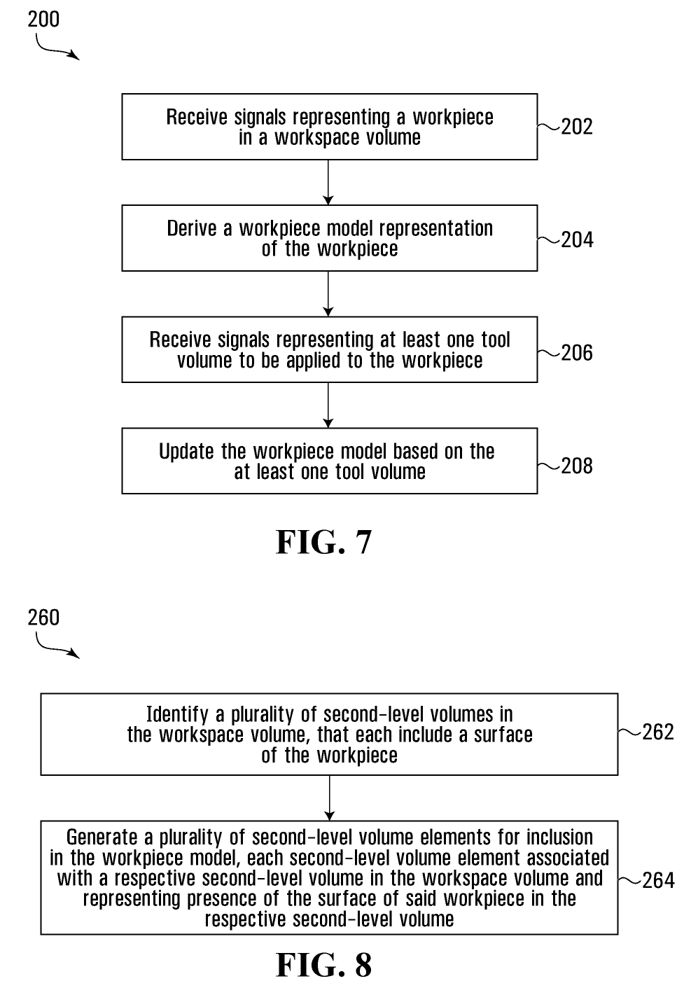

Referring now to FIG. 7, a flowchart depicting blocks of code for directing the simulator processor 100 shown in FIG. 6 to perform simulator functions in accordance with one embodiment is shown generally at 200. The blocks of code included in the flowchart 200 may be encoded in the block of codes 160 of the program memory 102 shown in FIG. 6, for example.

In some embodiments, flowchart 200 may be executed when a user or users of the simulator 20 wish to machine or cut the workpiece 16 or a similar workpiece using the milling machine 14 into a desired final shape and dimensions, but before proceeding with the cutting, the user wishes to verify that the result of the machining will be correct.

Referring to FIG. 7, the flowchart 200 begins with block 202 which directs the simulator processor 100 shown in FIG. 6 to receive signals representing a workpiece in a workspace volume. In various embodiments, a representation of a workpiece may have been previously provided and stored in the location 140 of the storage memory 104. Accordingly, block 202 may direct the simulator processor 100 to retrieve the representation of the workpiece 16 from the location 140 of the storage memory 104.

As discussed above, in some embodiments, prior to execution of the flowchart 200, a user may have used CAD and/or CAM tool to input the shape and dimensions of the workpiece 16 shown in FIG. 1 to generate a representation of the workpiece 16 and to cause the representation to be stored in the location 140 of the storage memory 104 shown in FIG. 6. In some embodiments the CAD and/or CAM tool used may be implemented in codes in the workpiece definition block of codes 162. In various embodiments, the representation stored in the location 140 of the storage memory 104 may include data defining a model of the workpiece 16. For example, in some embodiments, the representation may be a triangle mesh model of the workpiece 16, a visual representation of which is shown at 40 in FIG. 2.

Referring to FIG. 7, block 204 then directs the simulator processor 100 to derive a workpiece model representation of the workpiece. Block 204 may direct the simulator processor 100 to derive the workpiece model from the representation stored in the location 140 of the storage memory 104 shown in FIG. 6. Thus, block 204 may direct the simulator processor 100 to convert a triangle mesh model stored in the location 140 of the storage memory 104 into a workpiece model having a format as described in accordance with various embodiments herein.

As discussed above, the workpiece model may include first-level volume elements, second-level volume elements, and boundary surface elements. In some embodiments, block 204 may direct the simulator processor 100 to first identify second-level volumes in the workspace volume that include the surface of workpiece. Block 204 may then direct the simulator processor 100 to generate the first-level volume elements and associated second-level volume elements based on the identified second-level volumes. Block 204 may then direct the simulator processor 100 to generate the boundary surface elements for each second-level volume element that represents presence of a surface of the workpiece in an associated second-level volume.

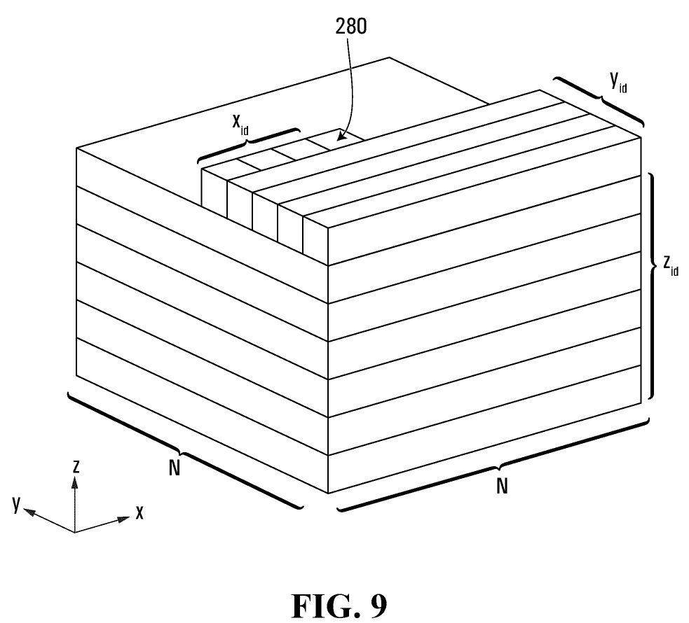

Referring now to FIG. 8, there is shown a flowchart 260 depicting blocks of code for directing the simulator processor 100 shown in FIG. 6 to perform second-level volume element generation functions in accordance with one embodiment. The blocks of code included in the flowchart 260 may be included in the block 204 of the flowchart 200 shown in FIG. 7.

Flowchart 260 begins with block 262 which directs the simulator processor 100 to identify a plurality of volumes in the workspace volume 18 that each include a surface of the workpiece 16. Block 262 may direct the simulator processor 100 to employ a boundary-first flood-voxelization approach for identifying second-level volumes that contain the surface of the workpiece. The second-level volumes identified as containing a surface of the workpiece may be referred to herein as surface second-level volumes.

In various embodiments, block 262 may direct the simulator processor 100 to identify the second-level volumes by identifying a plurality of volume identifiers, each associated with a particular volume in the workspace volume that includes the surface of the workspace. For example, in some embodiments, each second-level volume in the workspace volume may be identified by a 3D second-level volume grid location or set of coordinates in the workspace volume (x_{id}, y_{id}, z_{id}), indicating the position in the 3D second-level volume grid of the second-level volume. An example showing how x_{id}, y_{id}, and z_{id} may be determined for a second-level volume 280 in the workspace volume 18 is shown in FIG. 9. Notably, the first second-level volume in the workspace volume 18 may have an (x_{id}, y_{id}, z_{id}) of (0, 0, 0). In various embodiments, block 262 may direct the simulator processor 100 to identify the second-level volume elements by determining a plurality of coordinates (x_{id}, y_{id}, z_{id}), which each identify a second-level volume that includes the surface of the workpiece.

In various embodiments, converting between second-level volume x_{id}, y_{id}, z_{id} and true position of the volume may be done based on the second-level volume edge length, Lv. In some embodiments, the edge length of the second-level volume may be set such that fine features of the workpiece model can be modelled. For example, in some embodiments the second-level volume edge length may be 1 mm.

In various embodiments, block 262 may direct the simulator processor 100 to retrieve the triangle mesh representation of the workpiece from the location 140 of the memory 104 and to, for each triangle in the triangle mesh representation, perform the following three steps.

First, block 262 may direct the simulator processor 100 to identify the three second-level volumes in which the three vertices of the triangle reside and to determine that the surface of the workpiece is present in each of these volumes.

Second, block 262 may direct the simulator processor 100 to identify the second-level volumes through which each of the three edges of the triangle pass, via binary subdivision of the edges. Block 262 may direct the simulator processor 100 to determine that the surface of the workpiece is present in each of the second-level volumes that include a mid-point of an edge of the triangle, and then block 262 may direct the simulator processor 100 to subdivide the edge into two equal length edges and then again determine that the surface of the workpiece is present in each of the second-level volumes that include a mid-point of the subdivided edge. Block 262 may direct the simulator processor 100 to continue determining and subdividing the edges until both end points of the subdivided edge are in the same second-level volume or the second-level volumes including the end points of the subdivided edge are neighbors.

In various embodiments, the voxel chain for each set of second-level volumes defining an edge may be made to be 6-connected by identifying extra second-level volumes as needed. For example, block 262 may direct the simulator processor 100 to perform the following, for each second-level volume in the set of second-level volumes defining the voxel chain for the triangle edge. Block 262 may direct the simulator processor 100 to determine whether there is no face-neighbor (i.e., neighboring second-level volume that shares a face with the subject second-level volume) of the subject second-level volume present in the set. Block 262 may direct the simulator processor 100 to, if there is no face-neighbor of the subject second-level volume present in the set, first try to find edge-neighbors of it present in the set and, if found, identify/add to the set, a second-level volume that is face-neighbor to both the subject second-level volume and the edge-neighbor. In various embodiments, block 262 may direct the simulator processor 100 to, if no edge-neighbor is present in the set, get the vertex-neighbors of it present in the set, and identify/add to the set, all the second-level volumes incident at the common vertex of the subject second-level volume and the vertex-neighbor volume.

Third, block 262 may direct the simulator processor 100 to identify the second-level volumes in which the surface of the workpiece is present for the face interior of the triangle. Block 262 may direct the simulator processor 100 to identify a second-level volume through which the interior of the triangle passes as including the surface of the workpiece. This second-level volume may be considered a seed volume. The interior of the triangle may be defined herein as the inner face area of a triangle that is defined by three vertices and three linear edges. A second-level volume through which the interior of the triangle passes may be a volume for which all the linear boundaries that intersect the triangle's face plane do so in the triangle's inner face area. Block 262 may direct the simulator processor 100 to identify subsequent second-level volumes as volumes that include the surface of the workpiece by propagating outward from the seed volume into the neighboring second-level volumes through the edges of the volume that are crossing the triangle face plane and continuing the process for all such neighbors, which have not already been determined to include the surface of the workpiece.

After block 262 has been executed, each second-level volume that includes the surface of the workpiece may be identified. In various embodiments, block 262 may direct the simulator processor 100 to store a representation of coordinates (x_{id}, y_{id}, z_{id}) for each second-level volume identified as including the surface of the workpiece 16 in the location 141 of the storage memory 104.

In some embodiments, block 262 may direct the simulator processor 100 to store a map or record for associating each set of coordinates identifying a second-level volume that includes the surface of the workpiece 16 and the triangles of the input triangle mesh passing through the second-level volume in the location 141 of the storage memory 104. This map may be used when generating boundary surface elements, for example, such that only the triangles that intersect a second-level volume are considered for determining the boundary surface points. In various embodiments, the map and/or other maps described herein may be implemented as binary search trees, which may be self-balancing red-black trees or advanced binary search trees. In some embodiments, a standard template library map in a Microsoft™ VC++ library may be used as the binary tree.

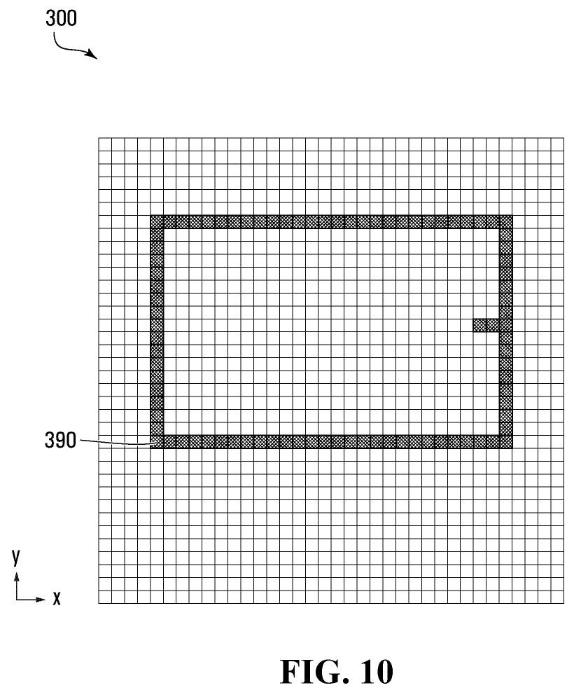

FIG. 10 shows a top view representation 300 of a layer of identified second-level volumes with zid=4, after block 262 has been executed, with shaded blocks representing the identified second-level volumes.

Referring back to FIG. 8, block 264 then directs the simulator processor 100 to generate a plurality of second-level volume elements for inclusion in the workpiece model, each of the second-level volume elements associated with an identified second-level volume from block 262 and representing presence of the surface of said workpiece in the respective volume. These second-level volume elements may be referred to herein as surface second-level volume elements.

In some embodiments, generating the second-level volume elements may involve generating the first-level volume elements first and then generating and associating the second-level volume elements with the first-level volume elements. In some embodiments, the simulator 20 may be configured to generate the first-level volume elements based on the identified second-level volumes from block 262.

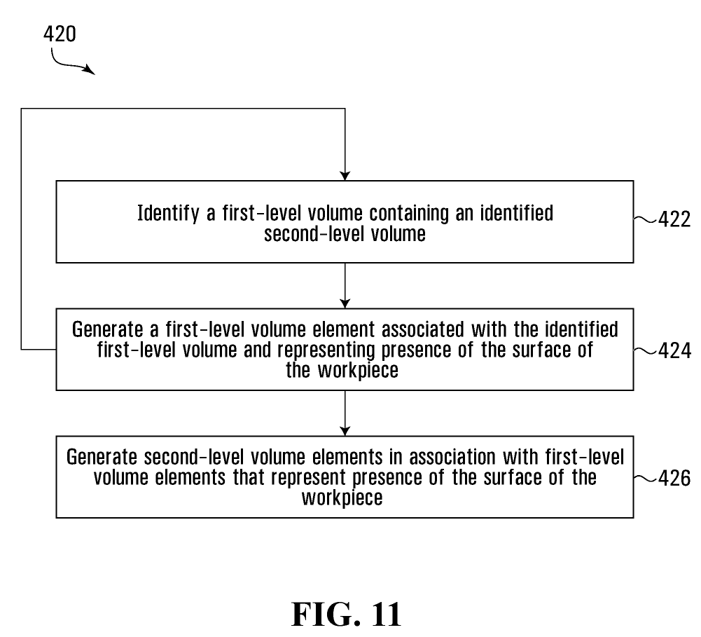

Referring now to FIG. 11, there is shown a flowchart 420 depicting blocks of code for directing the simulator processor 100 shown in FIG. 6 to perform first-level and second-level volume element generation functions in accordance with one embodiment. In various embodiments, the blocks of code of the flowchart 420 may be included in the block 264 of the flowchart 260 shown in FIG. 8.

Flowchart 420 includes blocks 422 and 424 which may be executed for every second-level volume identified at block 262 of the flowchart 260 shown in FIG. 8. In various embodiments, because the surface of the workpiece was determined to be included in the identified second-level volume, if a first-level volume includes the identified second-level volume, then the first-level volume also includes the surface of the workpiece. Accordingly, block 422 may direct the simulator processor 100 to identify a first-level volume containing an identified second-level volume that was identified at block 262 of the flowchart 260.

In various embodiments, block 422 may direct the simulator processor 100 to read one of the second-level volume coordinates stored in the location 141 of the storage memory 104 shown in FIG. 6. Block 422 may direct the simulator processor 100 to identify a first-level volume that contains the second-level volume identified by the retrieved coordinates. In various embodiments, block 422 may direct the simulator processor 100 to determine first-level volume coordinates X_{id}, Y_{id}, and Z_{id} for the first-level volume within which the second-level volume resides using the following equations:

X_{id}=floor(x_{id}/f);Y_{id}=floor(y_{id}/f);z_{id}=floor(z_{id}/f)

where f is the subdivision factor between the second and first level grid resolutions N₂ and N₁. Thus, in some embodiments where the first-level grid in the workspace volume 18 is a 9×9×9 grid and so the grid resolution is 9 and the second-level grid in the workspace volume 18 resolution is a 36×36×36 grid and so the grid resolution is 36, for example, f=36/9=4.

Accordingly, for example, in some embodiments, second-level volume 390 shown in FIG. 10 is identified by (x_{id}, y_{id}, z_{id}) of (4, 12, 4), which may have been stored in the location 141 at block 262 of the flowchart 260 shown in FIG. 8. Block 422 may direct the simulator processor 100 to identify a first-level volume element containing volume 390 by determining that a first-level volume identified by first-level volume X_{id}, Y_{id}, Z_{id} coordinates of (floor(4/4), floor(12/4), floor(4/4))=(1, 3, 1) contains the volume 390.

Block 424 then directs the simulator processor 100 to generate a first-level volume element associated with the identified first-level volume and representing presence of the surface of the workpiece. In some embodiments, block 424 may direct the simulator processor 100 to store the generated first-level volume element in the location 142 of the storage memory 104.

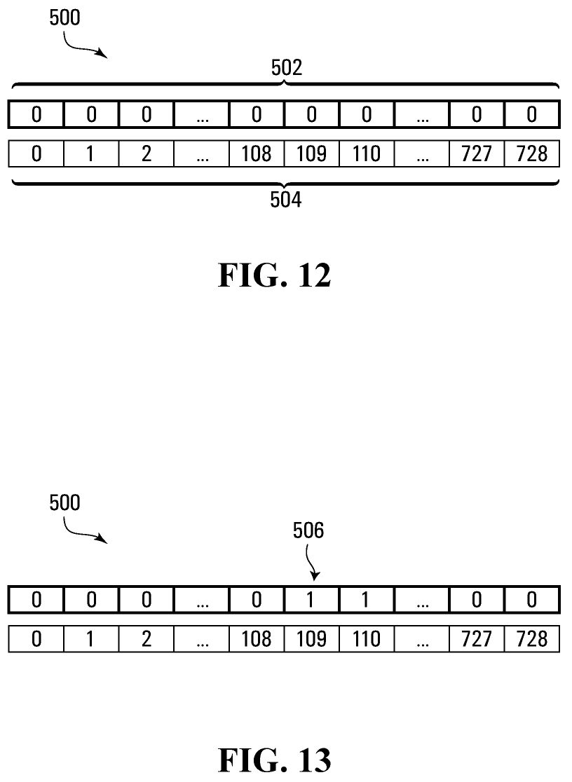

In a first instance of executing block 424, block 424 may direct the simulator processor 100 to generate a first-level volume element bit-array 500 as shown in FIG. 12 for including first-level volume element bits acting as first-level volume elements and to store the bit-array 500 in the location 142 of the storage memory 104. The bit-array 500 includes a plurality of bits 502, each at a respective index position 504 in the bit-array. In various embodiments, each bit may act as a first-level volume element and each of the index positions 504 associated with a respective one of the bits 502 may act as an identifier associated with the bit, this identifier uniquely identifying a particular first-level volume in the workspace volume 18.

In various embodiments, first-level volume coordinates (X_{id}, Y_{id}, Z_{id}) for a first-level volume in the workspace volume may be converted into index positions that act as first-level volume identifiers (V_{id}) using the following equation:

V_{id}=Z_{id}·N²+Y_{id}·N+X_{id}

where N is the cubical first-level volume grid resolution for the workspace volume 18. In various embodiments, this indexing of volume elements may help in enumerating the modelling space and/or in the random access of any volume element at consistent query time. In some embodiments, block 424 may direct the simulator processor 100 to store a grid resolution value of 9 in association with the first-level volume element bit-array 500.

Upon a first execution of block 424, block 424 may direct the simulator processor 100 to initialize all of the bits in the bit-array 500 to a value of 0. Block 424 may direct the simulator processor 100 to determine a first-level volume identifier (Vid) using the above equation and the coordinates determined at block 422 for the identified first-level volume. Block 424 may direct the simulator processor 100 to find a bit of the bits 502 shown in FIG. 12 that is associated with an index value equal to the determined V_{id} and to set that bit to a value of 1. In various embodiments, bits in the bit-array 500 that are set to 1 may act as first-level volume elements that represent presence of the surface of the workpiece in an associated first-level volume.

After blocks 422 and 424 have been executed for each of the identified second-level volumes, the bit-array 500 may include some bits set to 1 and some bits set to 0. In various embodiments, a bit set to 1 may represent presence of the surface of the workpiece in an associated first-level volume and a bit set to 0 may represent absence of the surface of the workpiece in an associated first-level volume

FIG. 13 shows the bit-array 500 after blocks 422 and 424 have been executed and the bit-array has been updated.

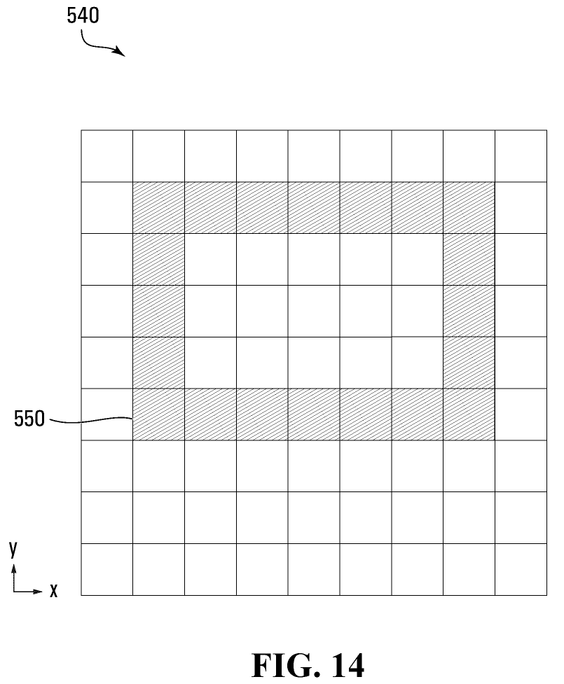

FIG. 14 shows a top view representation 540 of a layer of first-level volumes with zid=1, after block 424 has been executed, with first-level volumes shown as shaded for first-level volumes associated with bits in the bit-array 500 that are set to 1. Referring to FIG. 14, first-level volume 550 is identified by first-level volume coordinates (1, 3, 1) and so is identified by V_{id}=1*9² 3*9+1=109. Accordingly, bit 506 at index position 109 shown in FIG. 13 may act as a first-level volume element associated with the first-level volume 550 shown in FIG. 14.

Referring back to FIG. 11, block 426 then directs the simulator processor 100 to generate second-level volume elements in association with first-level volume elements that represent presence of the surface of the workpiece. Block 426 may direct the simulator processor 100 to generate respective second-level volume element bit-arrays, each associated with a first-level volume element bit that is set to 1. For example, in some embodiments, block 426 may direct the simulator processor 100 to associate the second-level volume bit-array with the first-level volume element by generating and storing a map from the first-level volume V_{id} of a bit set to 1 in the bit-array 500 to the associated second-level volume element bit-array.

Each bit in a second-level volume element bit-array may be associated with a respective second-level volume within a first-level volume. For example, in various embodiments, as shown in FIG. 4, each first-level volume may include 64 second-level volumes and so each second-level volume element bit-array may include 64 bits, each associated with an index position that acts as a second-level volume identifier for identifying a second-level volume within the first-level volume. In various embodiments, for memory efficiency, it may be preferable for the number of second-level volumes within each first-level volume to be a multiple of 8 so that the simulator 20 can use an integer number of bytes to represent the second-level volumes contained within each first-level volume.

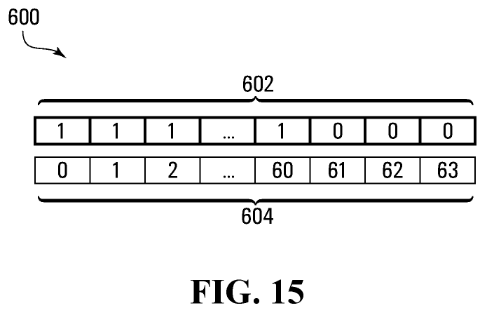

An exemplary second-level volume element bit-array, which may be generated and associated with the first-level volume element 506 of the first-level volume element bit-array 500 is shown at 600 in FIG. 15. The bit-array 600 includes bits 602 acting as second-level volume elements, each associated with a respective one of the index positions 604 acting as a second-level volume element identifier V_{id} for identifying a second-level volume within the first-level volume 550 shown in FIG. 14. The second-level V_{id}s may be defined generally similarly to the first-level V_{id}s, but spanning a volume only as large as the first-level volume within which the second-level volumes are located. Accordingly, the V_{id}s for second-level volumes included in a first-level volume as shown in FIG. 4, may range from 0 to 63 and thus the bit-array 600 may have length 64.

In various embodiments, block 426 may direct the simulator processor 100 to initialise the bits 602 to 0 and to set bits of the second-level volume element bit-array 600 shown in FIG. 15 to 1 for each bit that is associated with an index that identifies a second-level volume corresponding to one of the identified second-level volume coordinates stored in the location 141 of the storage memory 104. In various embodiments, a bit set to 1 may represent presence of the surface of the workpiece 16 in the second-level volume associated with the bit.

In various embodiments block 426 may direct the simulator processor 100 to generate and store a plurality of second-level volume element bit-arrays similar to the bit-array 600 shown in FIG. 15 in the location 144 of the storage memory 104, each in association with a bit from the first-level volume element bit-array 500 that is set to 1. In various embodiments, second-level volume element bit-arrays may only be generated for first-level volume element bits that are set to 1 and so memory usage may be reduced, compared to a second-level volume element bit-array that spans the entire workspace volume 18.

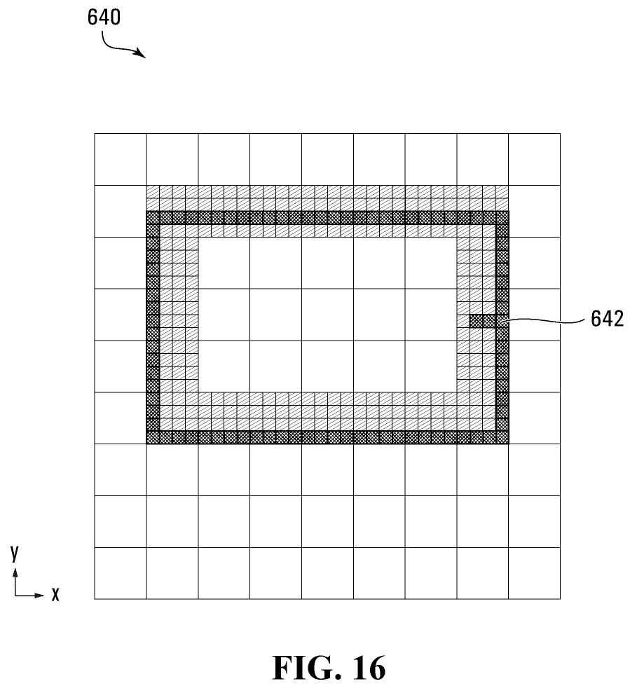

FIG. 16 shows a top view cross section of a representation 640 of the workpiece model, in accordance with various embodiments, with first-level volumes shown as shaded for first-level volumes associated with bits in the first-level volume element bit-array 500 that are set to 1 and second-level volumes shown with different shading for second-level volumes associated with bits in the second-level volume elements record bit-arrays stored in the location 144 of the storage memory that are set to 1.

Referring back to FIG. 8, in view of the foregoing, after the flowchart 260 has been executed, a plurality of first-level volume elements and a plurality of second-level volume elements may be stored in the locations 142 and 144 of the storage memory 104 shown in FIG. 6. In various embodiments, the workpiece model may include the stored first-level volume elements and second-level volume elements.

In some embodiments, the resolution provided by volume elements alone may not be sufficient for the workpiece modelling and/or manufacturing simulation. Accordingly, in some embodiments, the workpiece model may include boundary surface elements to provide sub-voxel resolution for the model. Thus, in some embodiments, block 204 may direct the simulator processor 100 to generate boundary surface elements for inclusion in the workpiece model.

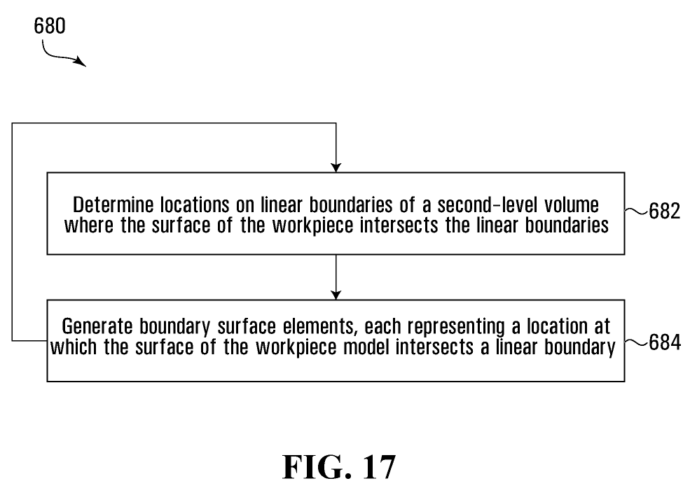

Referring to FIG. 17, there is shown a flowchart 680 depicting blocks of code for directing the simulator processor 100 shown in FIG. 6 to perform boundary surface element generation functions in accordance with one embodiment. In various embodiments, the blocks of code of the flowchart 680 may be included in the block 204 of the flowchart 200 shown in FIG. 7.

The flowchart 680 includes blocks 682 and 684 which may be executed for each second-level volume element that represents presence of the surface of the workpiece 16 in an associated second-level volume.

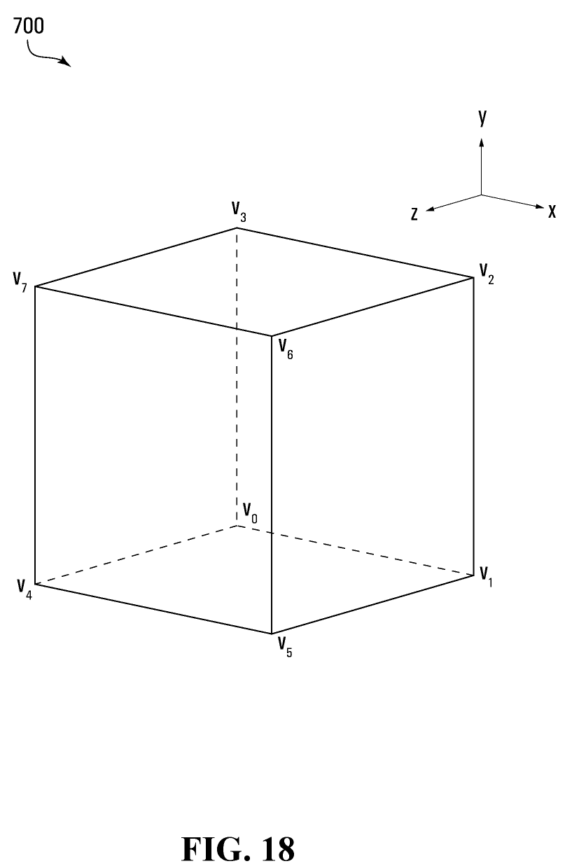

The flowchart 680 begins with block 682 which directs simulator processor 100 to determine locations on linear boundaries of a second-level volume where the surface of the workpiece intersects the linear boundaries. These locations may be referred to herein as boundary surface points. In various embodiments, a second-level volume may have vertices which can be numbered using the numbering convention shown at 700 in FIG. 18. Block 682 may direct the simulator processor 100 to determine boundary surface points on primary boundaries or primary edges of a second-level volume which are the boundaries between v0 and v1, v0 and v3, and v0 and v4. These primary boundaries may be referred to herein as the x-boundary, y-boundary, and z-boundary, respectively.

In some embodiments, block 682 may direct the simulator processor 100 to determine a representation of each boundary surface point representing a decimal number between 0 and 1 to represent location of the boundary surface point as a fraction of a length of the primary boundary along the primary boundary. For example, in some embodiments, the representation of a boundary surface point may include a 4-byte representation. In some embodiments, the representation of a boundary surface point may include an 8-byte representation for double precision values.

In some embodiments, block 682 may direct the simulator processor 100 to retrieve a map from the location 141 of the storage memory 104, which was previously generated at block 262 of the flowchart 260 shown in FIG. 8 and maps each surface second-level volume to at least one triangle in the triangle mesh and block 682 may direct the simulator processor 100 to consider only triangles associated with a second-level volume via the retrieved map, when determining boundary surface points for a second-level volume.

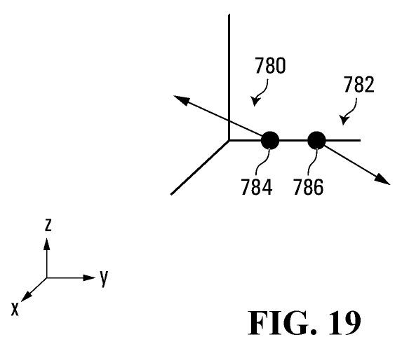

In some embodiments, block 682 may direct the simulator processor 100 to also determine a face direction for the surface of the workpiece at each boundary surface point. For example, block 682 may direct the simulator processor 100 to determine whether a face normal of the outer surface of the workpiece along the primary boundary is negative as shown at 780 in FIG. 19 or positive as shown at 782 in FIG. 19. Referring to FIG. 19, an interior of the workpiece 16 may be between boundary surface points 784 and 786.

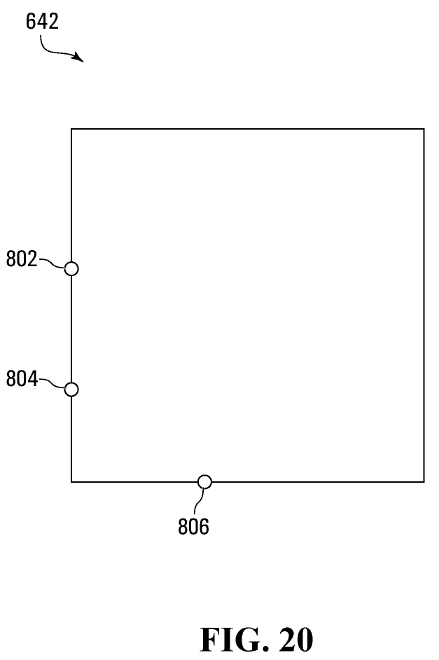

Referring to FIG. 20, boundary surface points for second-level volume 642 shown in FIG. 16, which is at the slit of the workpiece 16, are shown at 802, 804, and 806. In various embodiments, when considering the second level volume 642, block 682 may direct the simulator processor 100 to determine values representing the boundary surface points 802 and 804 for the y-boundary and to determine a value representing the boundary surface point 806 for the x-boundary. For example, block 682 may determine that location 802 is at a position or location 0.6 of the length of the y-boundary along the y-boundary, location 804 is at a position 0.25 of the length of the y-boundary along the y-boundary and location 806 is at a position 0.4 of the length of the x-boundary along the x-boundary. Block 682 may also determine that the face direction for boundary surface point 802 is negative, for boundary surface 804 is positive, and for boundary surface point 806 is positive.

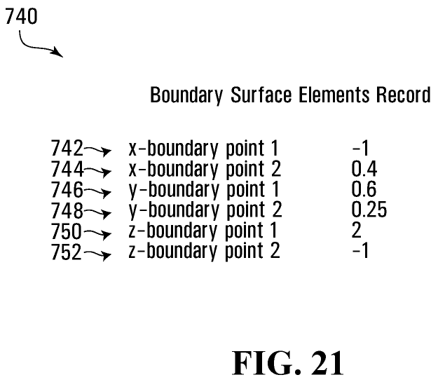

Once the boundary surface points have been determined, block 684 directs the simulator processor 100 to generate boundary surface elements, each representing a location at which a surface of the workpiece model intersects a linear boundary. Block 684 may direct the simulator processor 100 to generate a boundary surface elements record, such as the exemplary boundary surface elements record 740 shown in FIG. 21, and to associate the boundary surface elements record with a second-level volume element that is associated with the second-level volume considered at block 682. Block 684 may direct the simulator processor 100 to store the boundary surface elements record 740 in the location 146 of the storage memory 104. In various embodiments, block 684 may direct the simulator processor 100 to associate the boundary surface elements record with the second-level volume element by generating and storing in the location 146 of the storage memory 104 a map that maps from the first-level volume identifier and the second-level volume identifier associated with the second-level volume element bit in the second-level volume bit-array to the boundary surface elements record 740. In some embodiments, the boundary surface elements record 740 may be stored as a binary tree with the second-level volume identifier as a key and the set of boundary points for each second-level volume as the values. In some embodiments, binary search trees may be used, which may be self-balancing red-black trees or advanced binary search trees. In some embodiments, a standard template library map in a Microsoft™ VC++ library may be used as a binary tree for storing the boundary surface elements record 740.

Referring to FIG. 21, the boundary surface elements record 740 includes first and second x-boundary point fields 742 and 744 for storing first and second values representing boundary surface points on the x-boundary of the second-level volume. The values stored in the first and second x-boundary point fields 742 may act as boundary surface elements.

The boundary surface elements record 740 also similarly includes first and second y-boundary point fields 746 and 748 for storing first and second values representing boundary surface points on the y-boundary of the second-level volume and first and second z-boundary point fields 750 and 752 for storing first and second values representing boundary surface points on the z-boundary of the second-level volume.

In various embodiments, a value stored in the first boundary point fields 742, 746, and 750 may represent a surface of the workpiece that has a face normal along the primary boundary that is negative as shown at 780 in FIG. 19 and a value stored in the second boundary point fields 744, 748, and 752 may represent a surface of the workpiece that has a face normal along the primary boundary that is positive as shown at 782 in FIG. 19.

Block 684 may direct the simulator processor 100 to set corresponding values for the fields 742-752 according to any boundary surface points determined at block 682. In some embodiments, block 684 may direct the simulator processor 100 to initialize all of the fields 742, 744, 746, 748, 750, 752 shown in FIG. 21 to a value less than zero, such as, for example −1, which may denote an invalid boundary surface point, which may represent absence of an intersection point with the surface of the workpiece 16. Block 684 may direct the simulator processor 100 to, based on the intersection point 806, and the face direction at the intersection being positive, set the second x-boundary point field 744 to 0.4. Block 684 may direct the simulator processor 100 to, based on the intersection point 802, and the face direction at that intersection being negative, set the first y-boundary point field 746 to 0.6. Block 684 may direct the simulator processor 100 to, based on the intersection point 804, and the face direction at that intersection being positive, set the second y-boundary point field 748 to 0.25. Block 684 may direct the simulator processor 100 to determine from the values stored in the fields 744, 746 and 748 that the z-boundary is completely in the interior of the workpiece 16. Block 684 may direct the simulator processor 100 to denote this by setting the value of the first z-boundary point field 750 to a value greater than one, such as, for example 2. In various embodiments, when the first z-boundary point field 750 is set to 2, this may represent that the z-boundary edge is fully within the workpiece 16. In various embodiments, the above approach may facilitate setting up the values of the boundary surface elements record 740 based on the intersection location and the face direction. Thus, in some embodiments, vertices v₀, v₁, v₃, v₄ of the second-level volume may not need to be classified and this may make computations simpler.

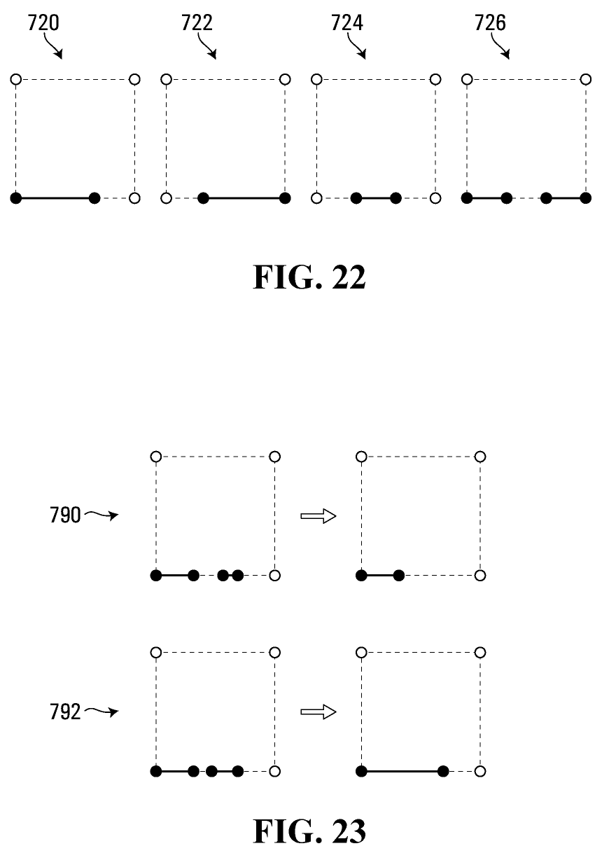

In view of the foregoing, in various embodiments, the boundary surface elements records permit two boundary surface points along each boundary. Accordingly, the boundary surface elements records may generally handle four possible edge crossing cases as shown 720, 722, 724, and 726 in FIG. 22. If there are more than two boundary surface points for one boundary, block 682 may direct the simulator processor 100 to simplify the points into one or two boundary surface points. In some embodiments, the simplified boundary surface points may be chosen based on comparing the interior segments of a boundary that are within the workpiece against the interior segments of the boundary that are outside the workpiece.

In various embodiments, block 682 may direct the simulator processor 100 to determine that the surface of the workpiece model intersects the boundary at more than two locations and thus determine that there are more than two boundary surface points. Block 682 may direct the simulator processor 100 to, in response to said determination, select one or two boundary surface points from the more than two boundary surface points based on a comparison of a sum length of interior segments of the linear boundary that are within the workpiece and a sum length of interior segments of the boundary that are outside the workpiece. Interior segments may be segments that are not bounded by a boundary vertex. In some embodiments, if the sum of the interior segments outside the workpiece is longer, then the small interior fragments that are within the workpiece are ignored (see boundary surface point simplification representation 790 of FIG. 23). In some embodiments, if the sum of the interior segments within the workpiece is longer, then the small interior gaps which are not within the workpiece are ignored (see boundary surface point simplification representation 792 of FIG. 23).

For example, in some embodiments, suppose a linear boundary has intersection points at 0<u1<u2<u3<u4<u5<1. If face directions at u1 and u5 are positive, the segment (0, u1) is alive (i.e., within the workpiece 16) and fixed to a voxel corner, and the interior segments or fragments of the boundary within the workpiece are (u2, u3) and (u4, u5). Then the sum of the lengths of interior segments within the workpiece=f=(u3−u2)+(u5−u4). The sum of the lengths of interior segments or gaps which are not within the workpiece=g=(u2−u1)+(u4−u3). Block 682 may direct the simulator processor 100 to, if f>g, fill in the gaps. Accordingly, block 682 may direct the simulator processor 100 to select u5 from the boundary surface points as a second boundary surface point and to proceed as if only the boundary surface point u5 had been identified.

Block 682 may direct the simulator processor 100 to, if f<=g, delete the fragments within the workpiece. Accordingly, block 682 may direct the simulator processor 100 to select u1 as the second boundary surface point and to proceed as if only the boundary surface point u1 had been identified.

If face directions at u1 and u5 are negative, the segment (u5, 1) is alive and fixed to a voxel corner, and the interior segments that are within the workpiece are (u1, u2) and (u3, u4). Then the sum of the lengths of interior segments within the workpiece=f=(u2−u1)+(u4−u3). And the sum of the lengths of interior gaps=g=(u3−u2)+(u5−u4). If f>g, gaps are filled and block 682 directs the simulator processor 100 to select u1 as a first boundary surface point and to proceed as if only the boundary surface point u1 had been identified. Otherwise fragments are deleted and block 682 directs the simulator processor 100 to select u5 as a first boundary surface point and to proceed as if only the boundary surface point u5 had been identified

In some embodiments, the above approach for simplifying more than two boundary surface points may be applied to cases with an odd number of intersections on a boundary. In some embodiments, if there are even number of intersections on a boundary, block 682 may direct the simulator processor 100 to, irrespective of the gap and fragment lengths, if the end corners are active, then fill the interior gaps and if the end corners are inactive, then ignore the interior segments that are within the workpiece.

In various embodiments, boundary surface locations are set only for the primary boundaries of a given second-level volume. Other boundaries are primary to some neighboring second-level volume and thus, in various embodiments, the boundary surface locations on all edges for a second-level volume are effectively present in a workpiece model that sets boundary surface locations only for the primary boundaries.

In view of the foregoing, once blocks 682 and 684 have been executed for each of the surface second-level volume elements, a respective boundary surface elements record, similar in format to the boundary surface elements record 740 shown in FIG. 21 may be associated with each of the surface second-level volume elements and stored in the location 146 of the storage memory 104.

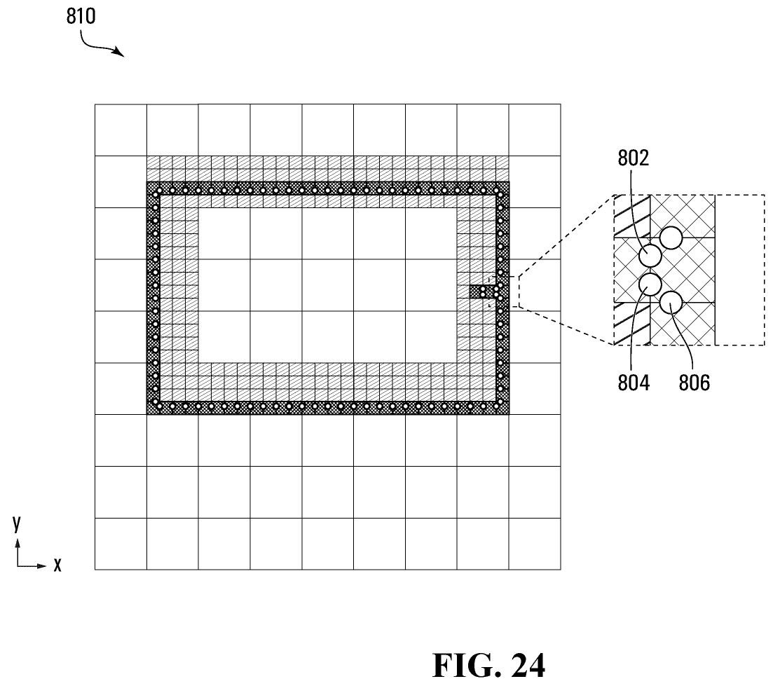

FIG. 24 shows a top view cross section of a representation 810 of the workpiece model, in accordance with various embodiments, with the boundary surface points represented by the boundary surface elements stored in the location 146 of the storage memory 104, after blocks 682 and 684 have been executed for each surface second-level volume, shown. The representation 810 shows boundary surface points 802, 804, and 806, for example,

Referring back to FIG. 7, in various embodiments, after block 204 has been executed, a workpiece model representation of the workpiece may be stored in the storage memory 104, for example, in the locations 140, 142, and 144 of the storage memory 104.

As discussed above, in some embodiments, after deriving the workpiece model, a user may wish to simulate manufacturing operations. The user may use CAD and/or CAM tools to provide a representation of a desired workpiece and cause the simulator 20 to store the representation in the location 148 of the storage memory 104. In some embodiments, the CAD and/or CAM tools may be implemented in codes in the tool path generation block of codes 164. The user may use the CAD and/or CAM tools to generate one or more proposed tool paths based on an analysis of the representation of the workpiece previously provided (e.g., the representation stored in the location 140 of the storage memory 104) and the representation of the desired workpiece stored in the location 148. The one or more tool paths may represent paths for one or more tools on the milling machine 14 to follow to cause the machine to cut the workpiece 16 into a desired final shape and dimensions. The user may use the CAD and/or CAM tools to cause the generated one or more tool paths to be stored in the location 150 of the storage memory 104 shown in FIG. 6.

In some embodiments, at least one tool volume may be derived from the one or more tool paths stored in the location 150, the at least one tool volume representing one or more volumes in the workspace volume 18 through which the tool of the machine 14 will pass and therefore remove material. A geometric simulation of the machining process may consider that portions of the workpiece 16 within the at least one tool volume will be removed during machining.

Referring to FIG. 7, once the workpiece model representation of the workpiece has been derived, the flowchart 200 may continue at block 206 which directs the simulator processor 100 to receive signals representing at least one tool volume to be applied to the workpiece. In various embodiments, block 206 may direct the simulator processor 100 to retrieve the representation of one or more tool paths stored in the location 150 of the storage memory 104 and to derive at least one tool volume from the one or more tool paths, the at least one tool volume representing one or more volumes in the workspace volume 18 through which the tool of the machine 14 will pass and therefore remove material. Block 206 may direct the simulator processor 100 to store a representation of the at least one tool volume in the location 152 of the storage memory 104.

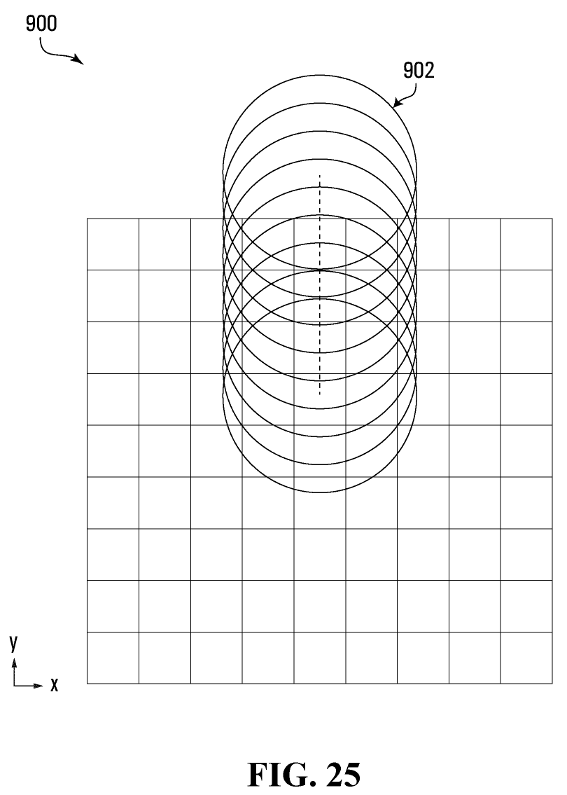

In some embodiments, the at least one tool volume may include a plurality of sampled tool volume instances which may be taken along a tool path at regular intervals and approximate cutter swept volumes. Referring to FIG. 25, there is shown at 900 a top view representation of a plurality of tool volume instances 902 which may be included in the representation of the at least one tool volume received at block 206. For context of location of the tool volume instances, the boundaries of the first-level volumes associated with the first level volume elements stored in the location 142 of the storage memory 104 are also shown in FIG. 25.

Referring back to FIG. 7, block 208 then directs the simulator processor 100 to update the workpiece model based on the at least one tool volume. In various embodiments, block 208 may direct the simulator processor 100 to update the workpiece model in a way that uses properties of the workpiece model to facilitate efficient updating.

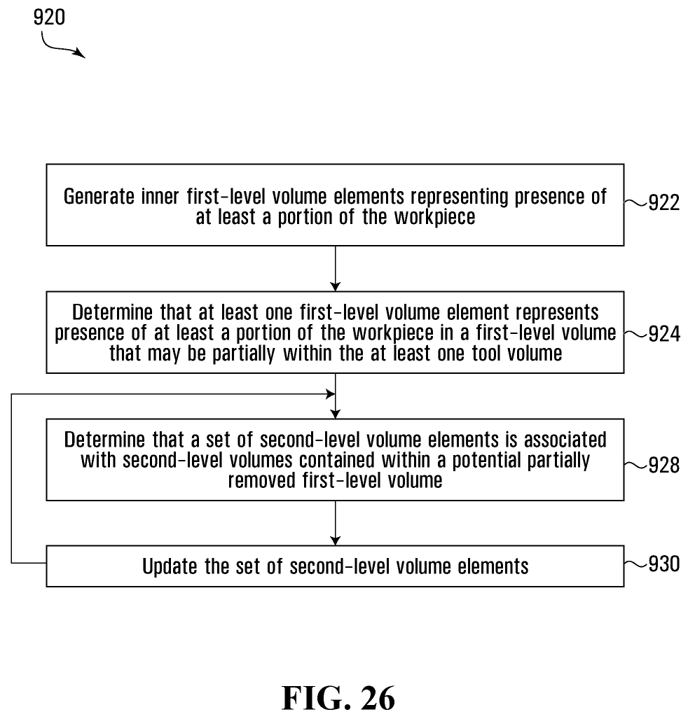

Referring now to FIG. 26, there is shown a flowchart 920 depicting blocks of code for directing the simulator processor 100 shown in FIG. 6 to perform workpiece model updating functions in accordance with one embodiment. The blocks of code included in the flowchart 920 may be included in the block 208 of the flowchart 200 shown in FIG. 7.

Flowchart 920 begins with block 922 which directs the simulator processor 100 to generate inner or interior first-level volume elements representing presence of at least a portion of the workpiece. In various embodiments, block 922 may direct the simulator processor 100 to identify bits in the first-level volume element bit-array 500 shown in FIG. 13 that are associated with first-level volumes that are within an interior of the workpiece 16 and to set these bits to 1. Once block 922 has been executed, each of the bits in the bit-array 500 shown in FIG. 13 that are set to 1 may represent presence of at least a portion of the workpiece 16 in the associated first-level volume of the workspace volume 18.

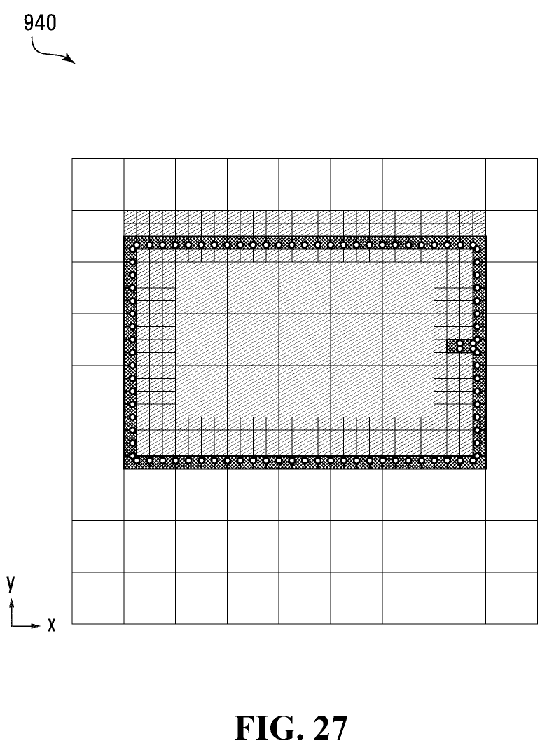

FIG. 27 shows a top view cross section of a representation 940 of the workpiece model, in accordance with various embodiments, after block 922 has been executed, with first-level volumes shown as shaded for first-level volumes associated with bits in the first-level volume element bit-array 500 that are set to 1.

Referring back to FIG. 26, the flowchart continues at block 924 which directs the simulator processor 100 to determine that at least one first-level volume element represents presence of at least a portion of the workpiece 16 in a first-level volume that may be partially within the at least one tool volume. In various embodiments, such first-level volume elements may be referred to herein as potential partially removed first-level volume elements, since part of the first-level volumes associated with these first-level volume elements may be removed during machining. The first-level volumes may be referred to herein as potential partially removed first-level volumes.

In various embodiments, execution of block 924 may direct the simulator processor 100 to identify which of the first-level volumes in the workspace volume 18 are (1) associated with active first-level volume elements and so include at least a portion of the workpiece 16 and (2) may be partially within the at least one tool volume and so may be partially removed by the machining process and so may include a tooled surface of the workpiece after machining. It is these first-level volumes which will be analysed further to determine/define a surface of the updated workpiece after machining.

In various embodiments, block 924 may direct the simulator processor 100 to update the workpiece model to represent absence of the workpiece in first-level volumes, which are completely within any tool volume. In various embodiments, by directing the simulator processor 100 to first update the workpiece model in this way, first-level volumes that will be removed and thus are known to not include a tooled surface can be ignored for subsequent simulation or updating steps and unnecessary computations may be avoided.

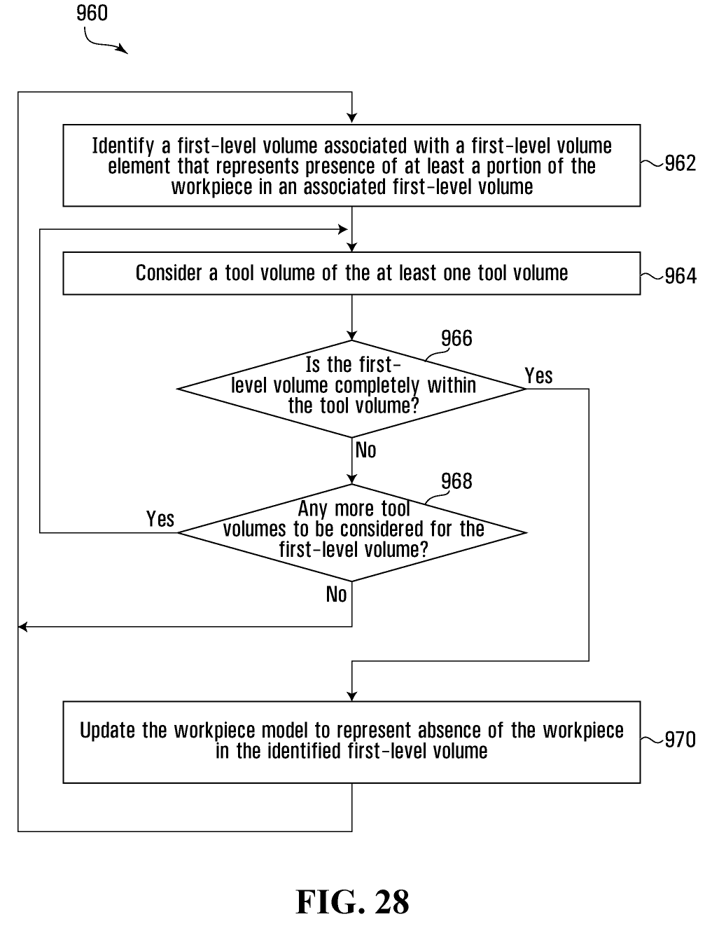

In some embodiments, block 924 may include blocks of code shown in flowchart 960 in FIG. 28, for directing the simulator processor 100 to update the workpiece model to represent absence of the workpiece in removed first-level volumes.

The flowchart 960 begins with block 962, which directs the simulator processor 100 to identify a first-level volume associated with a first-level volume element that represents presence of at least a portion of the workpiece in an associated first-level volume. In various embodiments, block 962 may direct the simulator processor 100 to read the first-level volume element bit-array 500 from the location 142 of the storage memory 104 to identify a bit that is set to 1, thus representing presence of at least a portion of the workpiece 16 in the first-level volume associated with the bit.

Block 962 may direct the simulator processor 100 to use the index position (acting as a first-level volume identifier V_{id}) associated with the identified bit to identify a first-level volume in the workspace volume 18 that is associated with the bit. Block 962 may direct the simulator processor 100 to derive the first-level volume coordinates X_{id}, Y_{id}, and Z_{id} from the first-level volume V_{id} using the following equations:

x_{id}=V_{id}% N

V_{id2D}=(V_{id}−x_{id})/N

y_{id}=V_{id2D}% N

z_{id}=(V_{id2D}−y_{id})/N

where % is the modulo operator.

Block 964 then directs the simulator processor 100 to consider a tool volume of the at least one tool volume. Block 964 may direct the simulator processor 100 to retrieve a representation of a first tool volume from the at least one tool volume stored in the location 152 of the storage memory 104.

Block 966 then directs the simulator processor 100 to determine whether the first-level volume identified at block 962 is completely within the tool volume considered at block 964. In various embodiments, block 966 may direct the simulator processor 100 to apply at least one criterion to the identified first-level volume in order to make this determination.

For example, in some embodiments, block 966 may direct the simulator processor 100 to determine whether a center of the first-level volume is both within the tool volume being considered and more than a threshold distance away from an envelope of the tool volume, where the envelope of the tool volume may be a boundary surface of the tool volume. Block 966 may direct the simulator processor 100 to determine a location of the center of the first-level volume using the X_{id}, Y_{id}, and Z_{id} and the edge length L of a first-level volume. For example, the location of the center may be determined to be at coordinates (x, y, z) in the workspace volume of (Lᵥ*(X_{id}+½), Lᵥ*(Y_{id}+½), Lᵥ*(Z_{id}+½)).

Block 966 may direct the simulator processor 100 to determine the distance of the center point from a closest point on the envelope of the tool volume and compare that distance to the threshold distance. In some embodiments, the threshold distance may be set to the maximum distance from the center of the first-level volume element to a boundary of the first-level volume element. For example, for the cubical first-level volume elements having edge length Lᵥ, the maximum distance may be determined as:

$${d}_{max , cp} = \frac{\sqrt{3} {L}_{v}}{2}$$

If at block 966, the simulator processor 100 determines that a center of the first-level volume is both within the tool volume and more than a threshold distance away from an envelope of the tool volume, block 966 may direct the simulator processor 100 to determine that the first-level volume is completely within the tool volume. If at block 966, the simulator processor 100 determines that the first-level volume is completely within the tool volume, block 966 directs the simulator processor 100 to proceed to block 970

Block 970 directs the simulator processor 100 to update the workpiece model to represent absence of the workpiece in the identified first-level volume, which may be considered a removed first-level volume, since it will be removed during manufacturing. In various embodiments, block 970 may direct the simulator processor 100 to set the bit associated with the identified first-level volume in the first-level volume element bit-array 500 to 0, to represent absence of the workpiece in the identified first-level volume.

Block 970 may then direct the simulator processor 100 to return to block 962 to identify another first-level volume associated with a first-level volume element that represents presence of at least a portion of the workpiece in an associated first-level volume. If at block 962, the simulator processor 100 cannot find a bit that is set to 1, or has already considered all of the bits that are set to 1, the flowchart may end.

Referring to FIG. 28, if at block 966, the simulator processor 100 determines that the first-level volume is not completely within the tool volume, block 966 directs the simulator processor 100 to proceed to block 968 which directs the simulator processor 100 to determine whether the at least one tool volume includes any further tool volumes which have not yet been considered for the identified first-level volume. If a further tool volume is found, block 968 directs the simulator processor 100 to return to block 964 and consider the further tool volume. If no further tool volumes are found, then the identified first-level volume is not completely within the at least one tool volume and block 968 directs the simulator processor 100 to return to block 962 to identify another first-level volume associated with a first-level volume element that represents presence of at least a portion of the workpiece in an associated first-level volume.

Accordingly, after the flowchart 960 has been executed, the first-level volume element bit-array 500 may be updated to include bits set to 0 for all bits associated with first-level volume elements that are completely within the at least one tool volume stored in the location 152 of the storage memory 104. In various embodiments, this may facilitate faster and easier calculations during subsequent simulation and/or when determining whether any first-level volumes may be partially within the at least one tool volume and thus may include a tooled surface (i.e., a new surface of the workpiece created by the tool removing material), since the removed first-level volumes need not be considered.

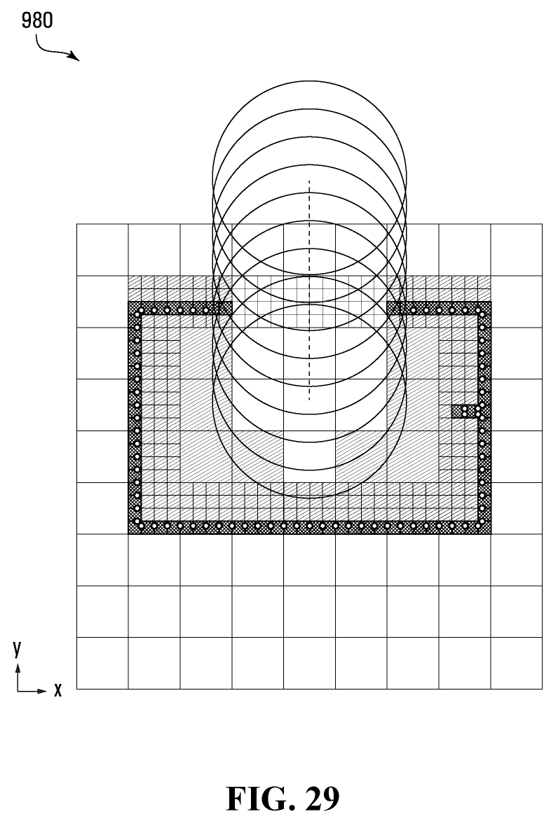

FIG. 29 shows a top view cross section of a representation 980 of the workpiece model after the flowchart 960 has been executed, in accordance with various embodiments.

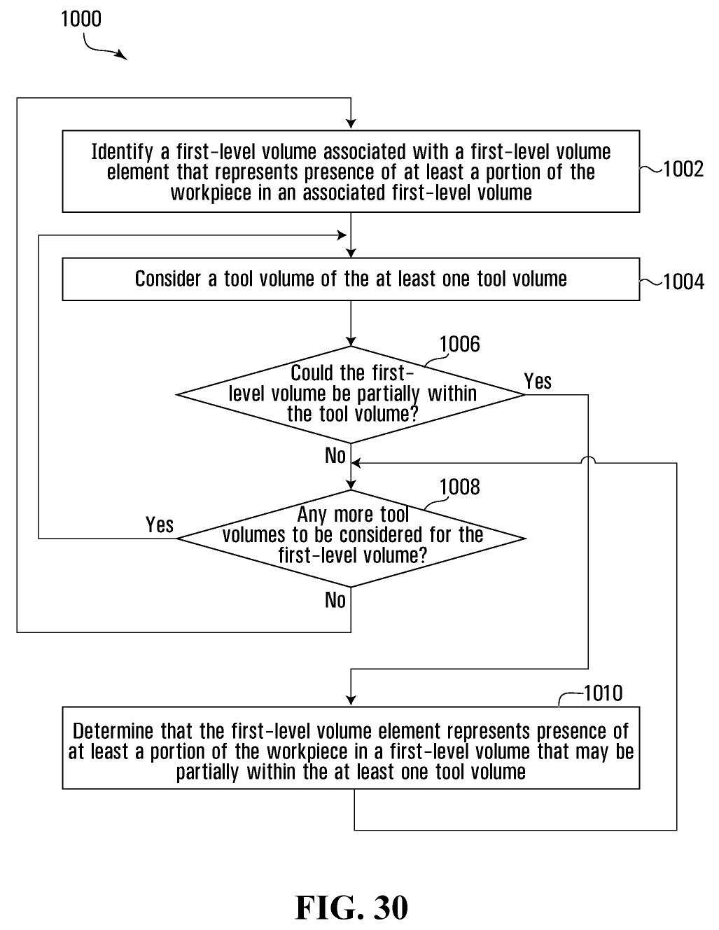

In various embodiments, block 924 of the flowchart 920 shown in FIG. 26 may include blocks of code shown in flowchart 1000 in FIG. 30 for determining that a first-level volume represents presence of at least a portion of the workpiece in a first-level volume that may be partially within the at least one volume. In various embodiments, the flowchart 1000 may be executed after the workpiece model has been updated to represent absence of the workpiece in the removed first-level volume elements, for example, as described with reference to the flowchart 960 shown in FIG. 28.

The flowchart 1000 begins with block 1002 which directs the simulator processor 100 to identify a first-level volume associated with a first-level volume element that represents presence of at least a portion of the workpiece in an associated first-level volume. Block 1002 may be generally similar to the block 962 of the flowchart 960 shown in FIG. 28, as described above.

In various embodiments, when block 1002 is executed after the flowchart 960 has been executed, block 1002 will not direct the simulator processor 100 to identify any first-level volume that will be completely removed by the machine 14 during the machining process. Accordingly, in various embodiments, when the flowchart 1000 is executed after the flowchart 960 shown in FIG. 28 has already been executed, this may facilitate avoidance of wasted computations considering first-level volumes that will be removed by the machine 14 during machining.

Block 1004 then directs the simulator processor 100 to consider a tool volume of the at least one tool volume. Block 1004 may be generally similar to the block 964 of the flowchart 960 shown in FIG. 28, as described above.

Block 1006 then directs the simulator processor 100 to determine whether the first-level volume could be partially within the tool volume. This determination may indicate whether the first-level volume could be partially removed during machining. In various embodiments, block 1006 may direct the simulator processor 100 to make the determination by applying at least one criterion to the first-level volume.

For example, in some embodiments, block 1006 may direct the simulator processor 100 to determine whether a center of the identified first-level volume is within a threshold distance of an envelope of the tool volume. Block 1006 may direct the simulator processor 100 to determine the distance from the center of the identified first-level volume to a closest point on the envelope of the tool volume and determine whether this distance is less than the threshold distance.

In various embodiments, the threshold distance may be set to the maximum distance from the center of the first-level volume element to a boundary of the first-level volume element such that determining that the center of the identified first-level volume is within a threshold distance of the envelope of the tool volume determines whether it is possible that the first-level volume could be partially within the at least one tool volume.

In various embodiments, if the simulator processor 100 determines that the center of the identified first-level volume is within a threshold distance of the envelope of the tool volume, block 1006 may direct the simulator processor 100 to proceed to block 1010.

Block 1010 directs the simulator processor 100 to determine that the first-level volume element represents presence of at least a portion of the workpiece in a first-level volume that may be partially within the at least one tool volume. This determination may indicate that the first-level volume could include a tooled surface.

In various embodiments, block 1010 may direct the simulator processor 100 to update the workpiece model to represent potential presence of a tooled surface of the workpiece in the identified first-level volume that was determined may be partially within the at least one tool volume. In various embodiments, block 1010 may direct the simulator processor 100 to generate a tooled surface element associated with the identified first-level volume for representing that the identified first-level volume could include a tooled surface and to store the tooled surface element in memory.

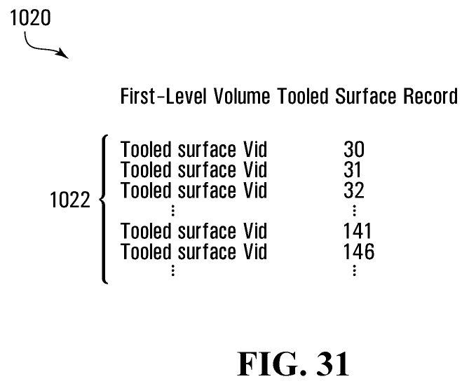

For example, in various embodiments, block 1010 may direct the simulator processor 100 to add the V_{id} of the first-level volume identified in block 1002, which was determined may be partially within the at least one tool volume, to a first-level volume tooled surface record, an exemplary one of which is shown at 1020 in FIG. 31, and to store the record in the location 154 of the storage memory 104.

Referring to FIG. 31, the first-level volume tooled surface record 1020 includes a plurality of tooled surface identifier fields 1022, each for storing a respective first-level volume identifier identifying a first-level volume that was determined may be partially within the at least one tool volume and associated with a first-level volume element that represents presence of at least a portion of the workpiece 16 in the first-level volume. In various embodiments, block 1010 may direct the simulator processor 100 to add a tooled surface identifier field to the tooled surface record 1020 and to store the V_{id} in the added tooled surface identifier field.

In some embodiments, block 1010 may direct the simulator processor 100 to generate and store a map associating the first-level volume identifier and the tool volume being considered, in the location 154 of the storage memory 104. This map may be used later when determining which second-level volumes may be partially within the at least one tool volume, since only those tool volumes associated by the map with the first-level volume containing the second-level volume may need to be considered.

After block 1010 has been executed or, if at block 1006, the simulator processor 100 determines that the first-level volume could not be partially within the tool volume, the simulator processor 100 is directed to proceed to block 1008 which directs the simulator processor 100 to determine whether the at least one tool volume includes any further tool volumes which have not yet been considered for the identified first-level volume. If a further tool volume is found, block 1008 directs the simulator processor 100 to return to block 1004 and consider the further tool volume. If no further tool volumes are found, then the identified first-level volume could not be partially within the at least one tool volume and block 1008 directs the simulator processor 100 to return to block 1002 to identify another first-level volume associated with a first-level volume element that represents presence of at least a portion of the workpiece in an associated first-level volume. If at block 1002, the simulator processor 100 cannot find a bit that is set to 1, or has already considered all of the bits that are set to 1, the flowchart may end.

Referring back to FIG. 26, after block 924 has been executed, a plurality of first-level volume elements may have been determined to represent presence of at least a portion of the workpiece 16 in a first-level volume element and the first-level volume tooled surface record stored in the location 154 may include a plurality of first-level volume identifiers.

Referring to FIG. 26, after block 924 has been executed, the flowchart continues at blocks 928 and 930. In various embodiments, blocks 928 and 930 may be executed for each of the first-level volume elements determined to be potential partially removed first-level volume elements at block 924. Block 928 directs the simulator processor 100 to determine that a set of second-level volume elements is associated with second-level volumes contained within a first-level volume associated with a potential partially removed first-level volume element. The set of second-level volume elements may act as a potential partially removed set of second-level volume elements.

In various embodiments, block 928 may direct the simulator processor 100 to read a first-level volume identifier from the first-level volume tooled surface record 1020 shown in FIG. 31 and stored in the location 154 of the storage memory 104 and to identify a second-level volume element bit-array associated with the first-level volume identifier. Block 928 may direct the simulator processor 100 to determine that the bits included in the identified second-level volume element bit-array are associated with a potential partially removed first-level volume element. Block 928 may direct the simulator processor 100 to determine that other information, such as boundary surface element records associated with the bits, is also associated with the potential partially removed first-level volume element.

In various embodiments, block 928 may direct the simulator processor 100 to identify bits in the identified second-level volume bit-array that are associated with second-level volumes that are within the workpiece 16 or internal to the workpiece 16 and set those identified bits to 1. Accordingly, after block 928 has been executed, each of the bits in the identified second-level volume bit-array that are set to 1 may represent presence of at least a portion of the workpiece 16 in a respective second-level volume.

If the simulator processor 100 is unable to find a second-level volume element bit-array associated with the first-level volume identifier, this may indicate that the first-level volume identified by the first-level volume tooled surface record was an interior first-level volume element. Block 928 may direct the simulator processor 100 to generate a second-level volume element bit-array and to associate the generated second-level volume bit-array with the first-level volume identifier. Block 928 may direct the simulator processor 100 to set all of the bits in the generated second-level volume element bit-array to 1. Block 928 may direct the simulator processor 100 to determine that the bits included in the generated second-level volume element bit-array are associated with a potential partially removed first-level volume element.

Block 930 then directs the simulator processor 100 to update the potential partially removed set of second-level volume elements determined at block 928. In some embodiments, block 930 may direct the simulator processor 100 to update information associated with the second-level volume element bit-array identified or generated at block 928 based on the at least one tool volume stored in the location 154 of the storage memory 104.

In various embodiments, block 930 may direct the simulator processor 100 to determine that at least one second-level volume element of the potential partially removed set of second-level volume elements represents presence of at least a portion of the workpiece 16 in a second-level volume that is partially within the at least one tool volume. The second-level volume and the second-level volume element may be referred to herein as a partially removed second-level volume and a partially removed second-level volume element. Block 930 may direct the simulator processor 100 to update the workpiece model to represent presence of a surface of the workpiece in the partially removed second-level volumes. For example, in some embodiments, block 930 may direct the simulator processor 100 to update and/or generate boundary surface elements associated with the partially removed second-level volumes.

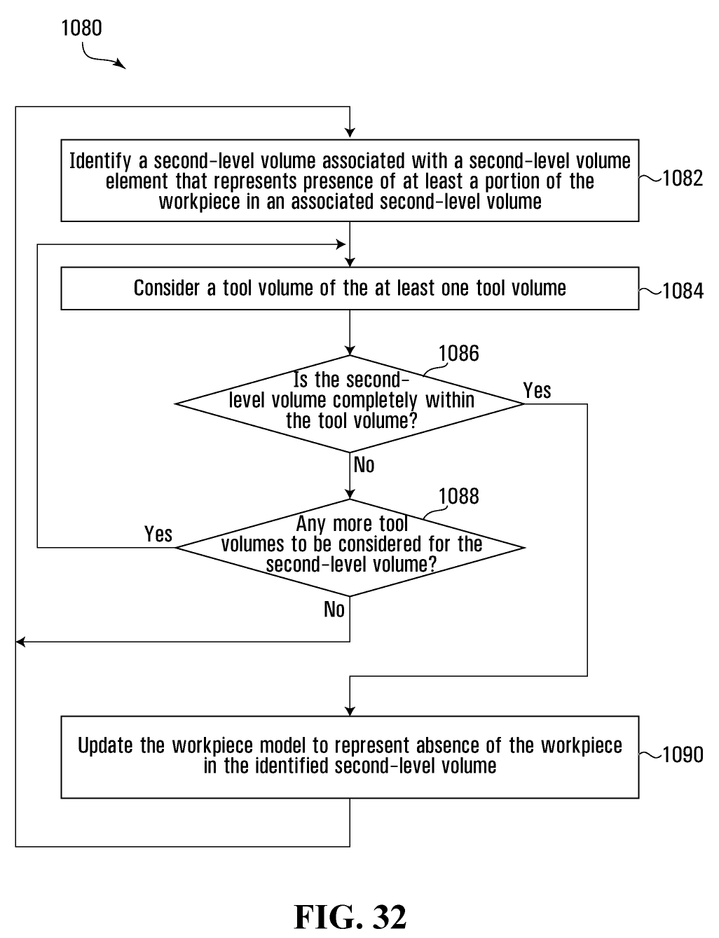

In some embodiments, block 930 of the flowchart 920 shown in FIG. 26 may include the blocks of code shown in flowchart 1080 of FIG. 32, for directing the simulator processor 100 to update the workpiece model to represent absence of the workpiece in removed second-level volumes, such that second-level volumes, which are completely within any tool volume are not considered for subsequent simulation.

The flowchart 1080 begins with block 1082, which directs the simulator processor 100 to identify a second-level volume associated with a second-level volume element that represents presence of at least a portion of the workpiece in an associated second-level volume. In various embodiments, block 1082 may direct the simulator processor 100 to read the second-level volume element bit-array identified or generated at block 928 of the flowchart 920 shown in FIG. 26 from the location 144 of the storage memory 104 to identify a bit that is set to 1, thus representing presence of at least a portion of the workpiece 16 in the second-level volume associated with the bit.

Block 1082 directs the simulator processor 100 to use the index position associated with the identified bit (acting as a second-level volume identifier), along with the first-level volume identifier associated with the second-level volume element bit-array being considered, to identify a second-level volume in the workspace volume 18 that is associated with the bit. Block 1082 may direct the simulator processor 100 to derive relative second-level volume coordinates (x_{id}, y_{id}, z_{id}) within the first-level volume and first-level volume coordinates (X_{id}, Y_{id}, Z_{id}) within the workspace volume 18 from the second-level volume identifier and the first-level volume identifier using the equations set out above regarding block 962.

Block 1084 then directs the simulator processor 100 to consider a tool volume of the at least one tool volume. Block 1084 may direct the simulator processor 100 to retrieve a representation of a first tool volume from the at least one tool volume stored in the location 152 of the storage memory 104. In some embodiments, block 1084 may direct the simulator processor 100 to consider only tool volumes which are associated with the first-level volume containing the second-level volume being considered via the map generated at block 1010 of the flowchart 1000 shown in FIG. 30.

Block 1086 then directs the simulator processor 100 to determine whether the second-level volume identified at block 1082 is completely within the tool volume considered at block 1084. In various embodiments, block 1086 may direct the simulator processor 100 to apply at least one criterion to the identified second-level volume in order to make this determination. Block 1086 may direct the simulator processor 100 to make generally similar calculations regarding the second-level volume as described above regarding block 966 and a first-level volume.

For example, in some embodiments, block 1086 may direct the simulator processor 100 to determine whether a center of the second-level volume is both within the tool volume being considered and more than a threshold distance away from an envelope of the tool volume. Block 1086 may direct the simulator processor 100 to determine a location of the center of the second-level volume using the first-level volume X_{id}, Y_{id}, and Z_{id} and the relative second-level volume x_{id}, y_{id}, and z_{id}, along with the edge length of a first-level volume Lᵥ₁ and the edge length of a second-level volume Lᵥ₂. For example, block 1086 may direct the simulator processor 100 to determine the center of the second-level volume to be at the following coordinates in the workspace volume 18:

(x,y,z)=(Lᵥ₁*X_{id1}+Lᵥ₂*(x_{id2}+½),Lᵥ₁*Y_{id1}+Lᵥ₂*(y_{id2}+½),Lᵥ₁*Z_{id1}+Lᵥ₂*(z_{id2}+½)

where X_{id1}, Y_{id1}, and Z_{id1} are the first-level volume X_{id}, Y_{id} and Z_{id}, and x_{id2}, y_{id2}, and z_{id2} are the second-level volume x_{id}, y_{id}, and z_{id}.

In some embodiments, the threshold distance may be set to the maximum distance from the center of the second-level volume element to a boundary of the second-level volume element, which may be determined generally as detailed above regarding block 962, but using the second-level volume edge length instead of the first-level volume edge length.

If at block 1086, the simulator processor 100 determines that a center of the second-level volume is both within the tool volume and more than a threshold distance away from an envelope of the tool volume, block 1086 may direct the simulator processor 100 to determine that the second-level volume is completely within the tool volume. If at block 1086, the simulator processor 100 determines that the second-level volume is completely within the tool volume, block 1086 directs the simulator processor 100 to proceed to block 1090

Block 1090 directs the simulator processor 100 to update the workpiece model to represent absence of the workpiece in the identified second-level volume, which may be considered a removed second-level volume, since it will be removed during manufacturing. In various embodiments, block 1090 may direct the simulator processor 100 to set the bit associated with the identified second-level volume in the second-level volume element bit-array to 0.

Block 1090 may then direct the simulator processor 100 to return to block 1082 to identify another second-level volume associated with a second-level volume element that represents presence of at least a portion of the workpiece in an associated second-level volume. If at block 1082, the simulator processor 100 cannot find a bit that is set to 1, or has already considered all of the bits that are set to 1 in the considered bit-array, the flowchart may end for that particular bit-array.

Referring to FIG. 32, if at block 1086, the simulator processor 100 determines that the second-level volume is not completely within the tool volume, block 1086 directs the simulator processor 100 to proceed to block 1088 which directs the simulator processor 100 to determine whether the at least one tool volume includes any further tool volumes which have not yet been considered for the identified second-level volume. In some embodiments, block 1088 may direct the simulator processor 100 to consider only tool volumes which are associated with the first-level volume containing the second-level volume being considered via the map generated at block 1010 of the flowchart 1000 shown in FIG. 30. If a further tool volume is found, block 1088 directs the simulator processor 100 to return to block 1084 and consider the further tool volume. If no further tool volumes are found, then the identified second-level volume is not completely within the at least one tool volume and block 1088 directs the simulator processor 100 to return to block 1082.

Accordingly, after the flowchart 1080 has executed, the second-level volume element bit-array identified or generated at block 928 may be updated to include bits set to 0 for bits associated with second-level volumes determined to be completely within the at least one tool volume stored in the location 152 of the storage memory 104. In various embodiments, this may facilitate faster and easier calculations for later simulation and/or determining whether any second-level volumes are partially within the at least one tool volume and thus are partially removed.

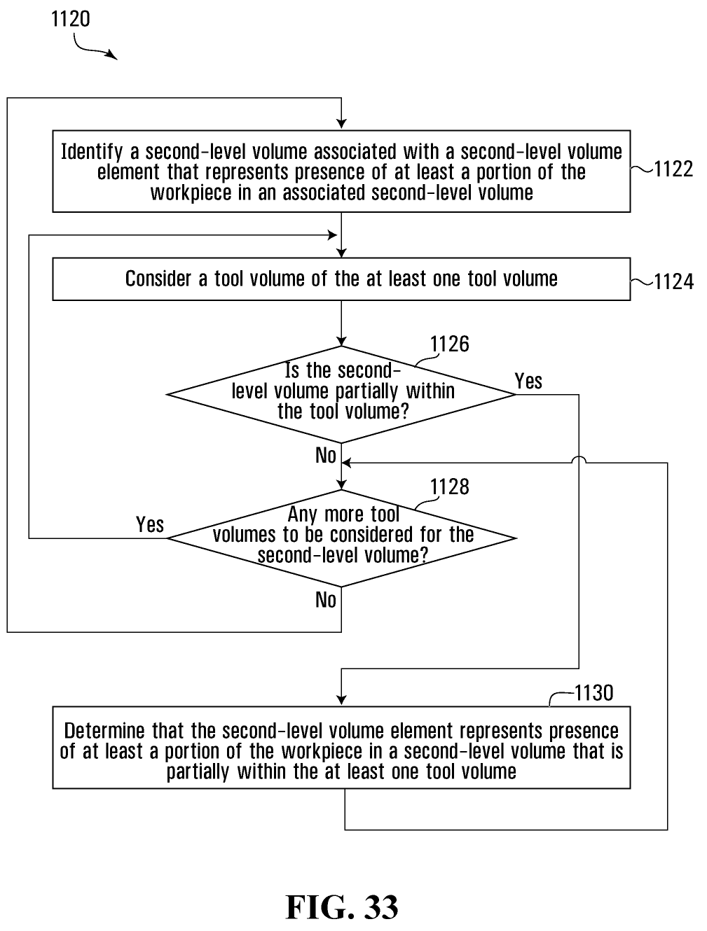

Referring now to FIG. 33, there is shown a flowchart at 1120 depicting blocks of code that may be included in the block 930 shown in FIG. 26, for directing the simulator processor 100 to determine that at least one second-level volume element is a partially removed second-level volume element that represents presence of at least a portion of the workpiece model in a second-level volume that is partially within the at least one tool volume. In various embodiments, the flowchart 1120 may be executed after the workpiece model has been updated to represent absence of the workpiece in the removed second-level volume elements, for example, as described with reference to the flowchart 1080 shown in FIG. 32.

The flowchart 1120 begins with blocks 1122 and 1124 which may be generally similar to blocks 1082 and 1084 of the flowchart 1080 shown in FIG. 32.

Block 1126 then directs the simulator processor 100 to determine whether the second-level volume is partially within the considered tool volume. Block 1126 may direct the simulator processor 100 to apply at least one criterion to the second-level volume. In various embodiments, block 1126 may direct the simulator processor 100 to determine whether a center of the identified second-level volume is within a threshold distance of an envelope of the tool volume, generally similar to as described herein having regard to block 1006 of the flowchart 1000 shown in FIG. 30, but applied to the second-level volume identified at block 1122.

If at block 1126 the simulator processor 100 determines that the center of the second-level volume is within the threshold distance of the envelope of the tool volume, block 1126 may direct the simulator processor 100 to apply additional criteria to the second-level volume to determine if the second-level volume is partially within the tool volume. For example, in some embodiments, block 1126 may direct the simulator processor 100 to determine whether at least one of the vertices of the second-level volume is within the tool volume and at least one of the vertices of the second-level volume is outside the tool volume. In various embodiments, if the simulator processor 100 determines that at least one of the vertices of the second-level volume is within the tool volume and at least one of the vertices of the second-level volume is outside the tool volume, block 1126 may direct the simulator processor 100 to determine that the second-level volume is partially within the considered tool volume, and to proceed to block 1130.

Block 1130 directs the simulator processor 100 to determine that the second-level volume element represents presence of at least a portion of the workpiece in a second-level volume that is partially within the at least one tool volume. This determination may indicate that the second-level volume could include a tooled surface.

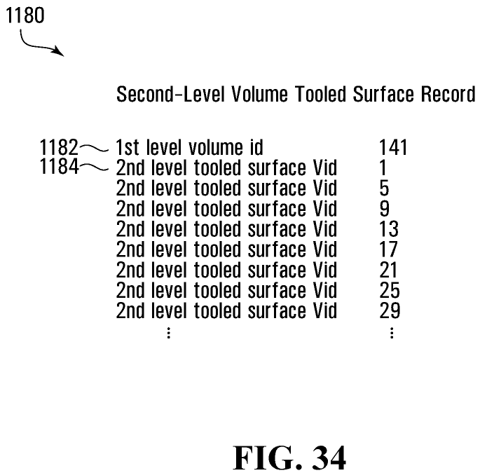

In various embodiments, block 1130 may direct the simulator processor 100 to update the workpiece model to represent potential presence of a tooled surface of the workpiece in the identified second-level volume that was determined to be partially within the at least one tool volume. In various embodiments, in a first execution, block 1130 may direct the simulator processor 100 to generate a second-level volume tooled surface record, an exemplary one of which is shown at 1180 in FIG. 34, and to store the record 1180 in the location 154 of the storage memory 104 shown in FIG. 6.

In various embodiments, block 1130 may direct the simulator processor 100 to associate the second-level volume tooled surface record 1180 with the first-level volume being considered. For example, in some embodiments, block 1130 may direct the simulator processor 100 to include a first-level volume identifier field 1182 in the second-level volume tooled surface record 1180 for storing a first-level volume identifier identifying the first-level volume with which the tooled surface record 1180 is associated. Block 1130 may direct the simulator processor 100 to add the second-level V_{id} of the second-level volume identified in block 1122, which was determined to be partially within the at least one tool volume to the second-level volume tooled surface record, in a second-level volume tooled surface field (e.g. 1184), to the record 1180.

In some embodiments, block 1130 may direct the simulator processor 100 to generate and store a map associating the second-level volume identifier and the tool volume being considered, in the location 154 of the storage memory 104. This map may be used later when determining which tool volumes to consider when updating the boundary surface elements associated with a particular second-level volume.

After block 1130 has been executed or, if at block 1126, the simulator processor 100 determines that the second-level volume is not partially within the tool volume, the simulator processor 100 is directed to proceed to block 1128 which directs the simulator processor 100 to determine whether the at least one tool volume includes any further tool volumes which have not yet been considered for the identified second-level volume. In some embodiments, block 1128 may direct the simulator processor 100 to consider only tool volumes which are associated with the first-level volume containing the second-level volume being considered via the map generated at block 1010 of the flowchart 1000 shown in FIG. 30.

If a further tool volume is found, block 1128 directs the simulator processor 100 to return to block 1124 and consider the further tool volume. If no further tool volumes are found, then the identified second-level volume is not partially within the at least one tool volume and block 1128 directs the simulator processor 100 to return to block 1122 to identify another second-level volume associated with a second-level volume element that represents presence of at least a portion of the workpiece in an associated second-level volume. If at block 1122, the simulator processor 100 cannot find a bit that is set to 1, or has already considered all of the bits that are set to 1 in the second-level volume element bit-array, the flowchart may end.

Referring back to FIG. 26, in various embodiments, after the flowchart 1120 shown in FIG. 33 has been executed, block 930 may direct the simulator processor 100 to update the workpiece model to represent presence of a surface of the workpiece in the second-level volumes associated with the at least one partially removed second-level volume elements. In various embodiments, block 930 may direct the simulator processor 100 to update and/or generate boundary surface elements associated with the partially removed second-level volumes. In some embodiments, the boundary surface elements may act as second-level volume elements, since existence of the boundary surface elements may represent presence of the workpiece in the associated second-level volumes.

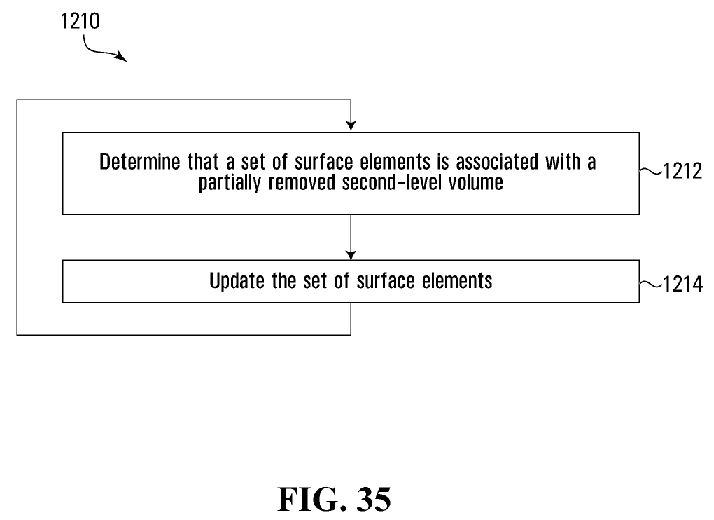

Referring to FIG. 35, in various embodiments, block 930 of the flowchart 920 shown in FIG. 26 may include blocks of code shown in flowchart 1210 of FIG. 35 for updating surface elements. In various embodiments, the flowchart 1210 may be executed for each of the second-level volume elements determined to be a partially removed second-level volume element at blocks 928 and 930. The flowchart 1210 includes block 1212, which directs the simulator processor 100 to determine that a set of surface elements is associated with a partially removed second-level volume. The flowchart 1210 also includes block 1214, which then directs the simulator processor 100 to update the set of surface elements.

In various embodiments, block 1212 may direct the simulator processor 100 to retrieve one of the second-level volume tooled surface records 1180 stored in the location 154 of the storage memory 104. Block 1212 may direct the simulator processor 100 to read a first-level volume identifier from the first-level volume identifier field and a second-level volume identifier taken from one of the second-level volume tooled surface fields and to identify a boundary surface elements record from the location 146 of the storage memory 104 that is associated with the first-level volume identifier and the second-level volume identifier. In various embodiments, blocks 1212 and 1214 may be repeatedly executed until each second-level volume identifier stored in each second-level volume tooled surface field of a second-level volume tooled surface record associated with a potential partially removed first-level volume and stored in the location 154 of the storage memory 104 has been considered.

If at block 1212, the simulator processor 100 cannot identify an associated boundary surface elements record in the location 146 of the storage memory, block 1212 may direct the simulator processor 100 to generate a boundary surface elements record and to store the boundary surface elements record in the location 154 of memory in association with the first-level volume identifier and the second-level volume identifier. For example, block 1212 may direct the simulator processor 100 to update a map stored in the location 146 of the storage memory 104 for associating the boundary surface elements records stored therein with first-level volume identifiers and second-level volume identifiers.

Block 1214 then directs the simulator processor 100 to update the set of boundary surface elements. Block 1214 may direct the simulator processor 100 to compute boundary surface points for each of the boundaries by calculating line-surface intersection points for each of the primary boundaries and the surface of each of the tool volumes included in the at least one tool volume. In some embodiments, if a set of boundary surface elements had been stored in location 154 of the storage memory 104 prior to execution of block 1212, block 1214 may direct the simulator processor 100 to consider only an active portion of the boundary within the workpiece 16, as determined from the existing boundary surface elements, when calculating boundary line-surface intersection points.

In some embodiments, block 1214 may direct the simulator processor 100 to consider only tool volumes which are associated with the second-level volume containing the boundaries being considered, via the map generated at block 1130 of the flowchart 1120 shown in FIG. 33, for example.

In various embodiments, block 1214 may direct the simulator processor 100 to determine the boundary surface points generally similarly to as detailed above having regard to block 682 of the flowchart 680 shown in FIG. 17, but applying opposite face directions to the boundary surface points because the tool volume represents removal of material rather than presence of material.

Block 1214 then directs the simulator processor 100 to remove from the sets of potential boundary surface points all boundary surface points that are within any volume included in the at least one tool volume. Block 1214 then directs the simulator processor 100 to store representations of the remaining boundary surface points in each set of potential boundary surface points in the boundary point fields of the boundary surface elements record being considered. Block 1214 may direct the simulator processor 100 to set values for the boundary point fields generally as described above having regard to block 684 of the flowchart 680 shown in FIG. 17.

As detailed above, in various embodiments, blocks 1212 and 1214 of the flowchart 1210 may be executed a plurality of times, once for each of the partially removed second-level volume elements in a potential partially removed set of second-level volume elements.

Referring back to FIG. 26, as detailed above, in various embodiments, blocks 928 and 930 of the flowchart 920 may be executed a plurality of times, once for each of the potential partially removed first-level volume elements, to update a plurality of potential partially removed sets of second-level volume elements.

Thus, in various embodiments, after blocks 922, 924, 928 and 930 have been executed, the updated workpiece model may include updated first-level volume elements that represent presence of at least a portion of the workpiece in an associated first-level volume after machining and updated second-level volume elements that represent presence of a surface of the workpiece in an associated second-level volume after machining. In some embodiments, a second-level volume element bit of a bit-array may be considered to represent presence of a surface of the workpiece in an associated second-level volume if the second-level volume element bit is set to 1 and is associated with a boundary surface elements record stored in the location 146, for example, via a map that maps from the first-level volume identifier and the second-level volume identifier associated with the second-level volume element bit in the second-level volume bit-array to the boundary surface elements record.

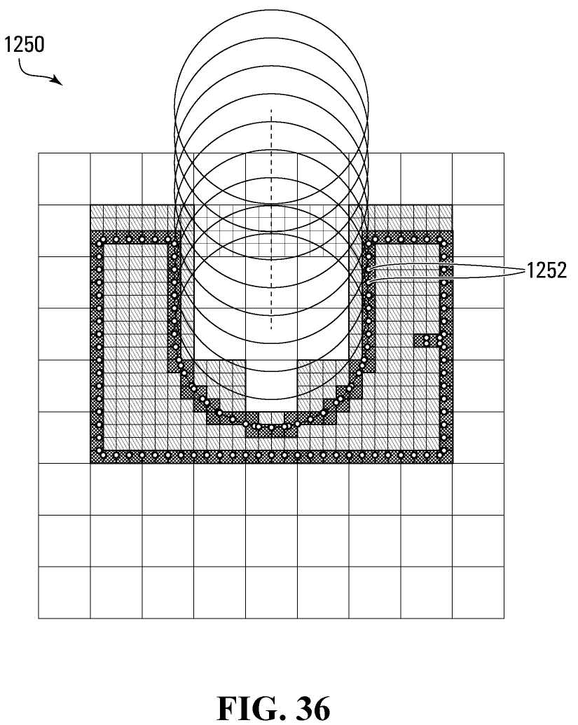

FIG. 36 shows a top view cross section of a representation 1250 of the workpiece model, in accordance with various embodiments, after blocks 928 and 930 have been executed for each of the potential partially removed first-level volumes. The representation 1250 includes first-level volumes shown as shaded for first-level volumes associated with bits in the first-level volume element bit-array 500 that are set to 1. The representation 1250 includes second-level volumes shown with different shading for second-level volumes that are both (1) associated with bits in the second-level volume elements record bit-arrays stored in the location 144 of the storage memory that are set to 1 and (2) associated with a boundary surface record stored in the location 146 of the storage memory 104. The representation 1250 includes representations of boundary surface points associated with boundary surface elements records stored in the location 146 of the storage memory (See for example representations at 1252).

Accordingly, once flowchart 920 has been executed, there may be stored in the locations 142, 144, 146 of the storage memory 104 information acting as an updated workpiece model, representing a prediction or simulation of what the workpiece 16 would look like after the tool path stored in the location 150 of the storage memory is used by the machine 14 to machine the workpiece 16.

Referring back to FIG. 7, in various embodiments, after block 208 has been executed and an updated workpiece model is stored in the storage memory 104, the user may wish to analyze the updated workpiece model and so the user may wish to export for analysis and/or view the updated workpiece represented by the updated workpiece model. Accordingly, the user may use the user interface system 26 to interact with the simulator 20 and cause the simulator processor 100 to execute updated workpiece model representation functions.

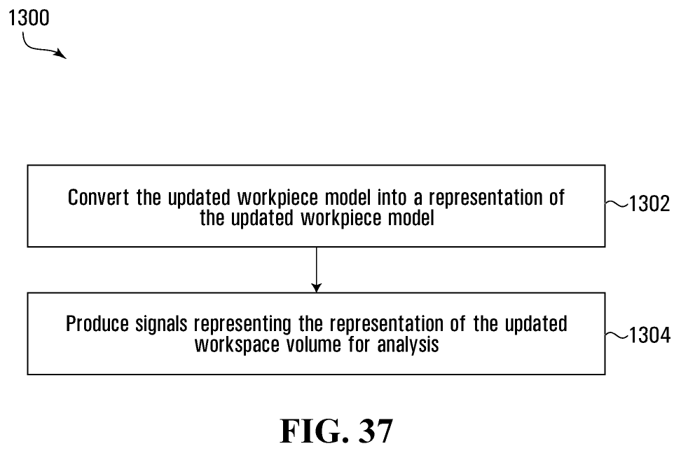

In some embodiments, the format of the workpiece model stored in the locations 142, 144, and/or 146 may not be easily analysed, rendered, and/or displayed compared to other formats and so, the simulator 20 may be configured to convert the workpiece model into another format for analysis and display. Accordingly, the flowchart 1300 shown in FIG. 37 for directing the simulator processor 100 to perform updated workpiece model conversion and representation functions may be initiated when the user wishes to analyze, export, and/or display a representation of the updated workpiece model. In various embodiments, the flowchart 1300 may be included in the block of codes 160 for directing the simulator processor 100 to perform simulator functions.

Flowchart 1300 begins with block 1302 which directs the simulator processor 100 to convert the updated workpiece model into another format representing the updated workpiece model. In some embodiments, block 1302 may direct the simulator processor 100 to convert the updated workpiece model into another modelling format, for which analysis and rendering software may be available. For example, in various embodiments block 1302 may direct the simulator processor 100 to convert the workpiece model into a triangle mesh model representation. Block 1302 may direct the simulator processor 100 to store the converted representation of the updated workpiece model in the location 156 of the storage memory 104.

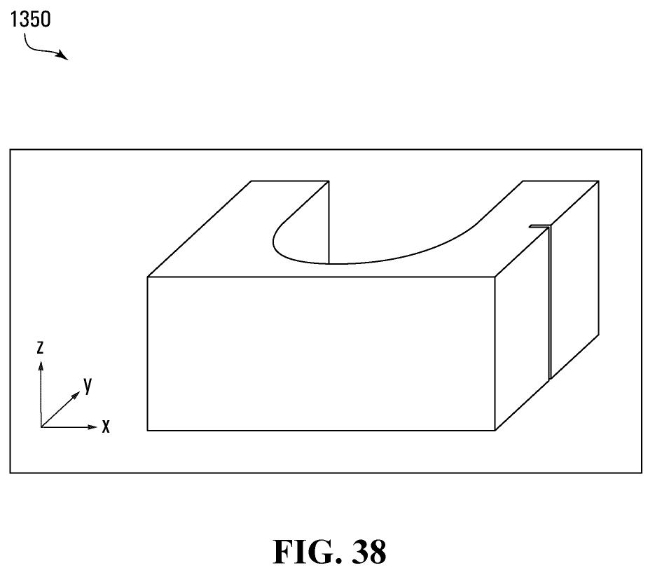

Block 1304 then directs the simulator processor 100 to produce signals representing the converted representation of the updated workpiece model for analysis. In various embodiments, block 1304 may direct the simulator processor 100 to transmit signals representing the triangle mesh representation stored in the location 156 of the storage memory to the user interface system 26 via the interface 120 of the I/O interface 112, to cause a display of the user interface system 26 to display a representation of the triangle mesh representation of the updated workpiece model. For example, referring to FIG. 38, there is shown at 1350 a smoothed visual representation of the triangle mesh representation which may be displayed by the display of the user interface system 26, in accordance with various embodiments of the invention.

In some embodiments, conversion of the workpiece model into another format may not be required, if a computer is able to analyze, render, and/or display the updated workpiece model without any conversion, and so in some embodiments, block 1302 of the flowchart 1300 may be omitted.

If analysis of the workpiece model is positive, then a user may wish to cause the workpiece to be manufactured using the tool path stored in the location 150 of the storage memory 104. Accordingly, a user may cause the tool path to be provided to the machine 14. For example, the user may use the user interface system 26 to interact with the simulator and cause the simulator 20 to output the tool path to the removable memory 128 via the interface 130, and the user may provide the tool path via the removable memory 128 to the machine 14. Upon receiving the tool path, the machine 14 may proceed with machining the workpiece 16.

### Various Embodiments

While embodiments have been described above wherein the workpiece model includes first-level volume elements and second-level volume elements, in various embodiments, fewer or more levels of volume may be included. For example, in some embodiments, the first-level volume elements may be omitted. In some embodiments, there may be one or more additional levels of volume elements associated with volumes that are larger than the first-level volume elements.

In some embodiments, the representation of the workpiece stored in the location 140 of the storage memory 104 may include a different representation that is not a triangle mesh representation. For example, in some embodiments, the representation of the workpiece may include a NURBS-based curved surface boundary input representations. In some embodiments, block 202 may direct the simulator processor 100 to generate a triangle mesh approximation of the NURBS-based curved surface or block 204 may direct the simulator processor 100 to compute line-NURBS surface intersections.

In some embodiments, blocks 202 and 204 of the flowchart 200 shown in FIG. 7 may be omitted. For example, in some embodiments, a user may generate the workpiece model directly, instead of first generating a triangle mesh representation of the model and then generating the workpiece model from the triangle mesh representation. Alternatively, in some embodiments, the simulator 20 may receive a workpiece model already in the format described herein and the simulator 20 may store the workpiece model in the locations 142, 144, and 146.

While in various embodiments described above, the milling machine 14 is discussed, in some embodiments, another manufacturing machine may be used in the system 10 shown in FIG. 1. For example, in some embodiments, another volume removal tool or tools may be used where “tool” means a “Boolean tool” that updates a workpiece model and may include tools other than a “milling cutter”. In some embodiments, another material removal tool that follows a tool path while machining may be used, such as, for example a drilling tool, a boring tool and/or a turning tool.

In some embodiments, block 204 may direct the simulator processor 100 to generate the first-level volume elements using another process other than that described with respect to the flowchart 420 shown in FIG. 11. For example, in various embodiments, block 204 may direct the simulator processor 100 to generate the first-level volume elements by identifying first-level volumes that include the surface of the workpiece using generally the same process as described with respect to block 262 of the flowchart 260 shown in FIG. 8 and generating the first-level volume elements using generally the same process as described with respect to block 426 of the flowchart 420 shown in FIG. 11.

In some embodiments, the representation of the at least one tool volume stored in the location 152 of the storage memory 104 shown in FIG. 6 may include a swept volume region representing the tool volume through which the tool is swept when following the tool path or another representation of at least one tool volume.

In some embodiments, flowcharts 960 and 1080 shown in FIGS. 28 and 32 may be omitted or may not be executed before executing flowcharts 1000 and 1090 shown in FIGS. 30 and 33, to determine that volumes are partially within the tool volume. For example, in some embodiments, the at least one tool volume may not include any overlapping volumes and execution of the flowcharts 1000 and 1090 may not increase efficiency of the system. For example, in some embodiments, the at least one tool volume may include one or more swept volume regions that do not include any overlapping volumes.

In some embodiments, block 922 of the flowchart 920 shown in FIG. 26 may be included as part of block 204 shown in FIG. 7 and may be executed when deriving the workpiece model.

In some embodiments, block 922 of the flowchart 920 shown in FIG. 26 may direct the simulator processor 100 to identify bits in each second-level volume bit-array that are associated with second-level volumes that are within the workpiece 16 or internal to the workpiece 16 and set those identified bits to 1. Accordingly, before block 928 of the flowchart 920 shown in FIG. 26 has been executed, each of the bits in the identified second-level volume bit-array that are set to 1 may represent presence of at least a portion of the workpiece 16 in a respective second-level volume. In such embodiments, block 928 may not need to identify bits in the identified second-level volume bit-array that are associated with second-level volumes that are within the workpiece 16 or internal to the workpiece 16 and set those identified bits to 1.

In some embodiments, applying the at least one criterion to a volume to determine whether the volume is completely within a tool volume may involve considering each of the vertices of the volume and determining whether each vertex is within the tool volume. If all of the vertices are within the tool volume, it may be determined that the first-level volume is within the tool volume.

In some embodiments, the simulator 20 may be configured to generate the model of the workpiece, but a user may not wish to use the simulator to simulate manufacturing. In such embodiments, blocks 206 and 208 of the flowchart 200 may be omitted.

In some embodiments, block 262 of the flowchart 260 shown in FIG. 8 may direct the simulator processor 100 to store the representation of the coordinates (x_{id}, y_{id}, z_{id}) for each second-level volume identified as including the surface of the workpiece 16 as respective second-level volume identifiers, V_{id}=z_{id}·N²+y_{id}·N+x_{id}, obtained with appropriate value of N spanning the entire workspace volume 18. In some embodiments, this may facilitate efficient use of memory.

In some embodiments, block 1126 of the flowchart 1120 shown in FIG. 33 may direct the simulator processor 100 to determine whether the second-level volume may be partially within the tool volume, generally as described above regarding block 1006 of the flowchart 1000 shown in FIG. 30.

In some embodiments, block 1006 of the flowchart 1000 shown in FIG. 30 may direct the simulator processor 100 to determine whether the first-level volume is partially within the tool volume, generally as described above regarding block 1126 of the flowchart 1120 shown in FIG. 33.

While specific embodiments of the invention have been described and illustrated, such embodiments should be considered illustrative of the invention only and not as limiting the invention as construed in accordance with the accompanying claims.

1. A computer-implemented method of geometric modeling to facilitate simulation for manufacturing operations, the method comprising:
causing at least one processor to receive signals representing a workpiece in a workspace volume; and
causing the at least one processor to derive, based on said signals representing the workpiece, a workpiece model representation of the workpiece, said deriving comprising:
causing the at least one processor to identify a plurality of volumes in the workspace volume that each include a surface of the workpiece;
causing the at least one processor to generate a plurality of volume elements for inclusion in the workpiece model, each volume element associated with a respective identified volume in the workspace volume and representing presence of the surface of said workpiece in the respective identified volume;
for each of the volume elements:
for at least one linear boundary of a set of linear boundaries of the volume associated with the volume element:
causing the at least one processor to determine at least one location on the linear boundary where the surface of said workpiece intersects the linear boundary; and
in response to said determining, causing the at least one processor to generate at least one boundary surface element associated with the volume element for inclusion in the workpiece model, the at least one boundary surface element associated with the linear boundary and representing at least one location at which the surface of said workpiece model intersects the linear boundary;
wherein for at least one of the volume elements:
for at least one linear boundary of a set of linear boundaries of the volume associated with the volume element:
causing the at least one processor to determine said at least one location on the linear boundary where the surface of said workpiece intersects the linear boundary comprises causing the at least one processor to determine first and second different locations on the linear boundary where the surface of said workpiece intersects the linear boundary; and
causing the at least one processor to generate the at least one boundary surface element associated with the volume element comprises causing the at least one processor to generate first and second boundary surface elements that represent the first and second different locations on the linear boundary where the surface of said workpiece intersects the linear boundary.

2. The method of claim 1 wherein each of the volumes is a cube and for each of the volumes, the set of linear boundaries of the volume comprises first, second, and third perpendicular edge boundaries.

3. The method of claim 1 wherein each of the boundary surface elements represents a face direction of the surface at the at least one location on the linear boundary.

4. The method of claim 1 wherein causing the at least one processor to generate at least one of the at least one boundary surface element comprises:
causing the at least one processor to determine that the surface of said workpiece model intersects the linear boundary at more than two locations; and
causing the at least one processor to select the at least one location from the more than two locations based on a comparison of a sum length of interior segments of the linear boundary that are within the workpiece and a sum length of the interior segments of the linear boundary that are outside of the workpiece.

5. The method of claim 1 wherein the plurality of volume elements are a plurality of second-level volume elements, each second-level volume element associated with a second-level volume in the workspace volume and representing presence of the surface of said workpiece in the second-level volume and wherein causing the at least one processor to derive the workpiece model representation of the workpiece comprises causing the at least one processor to generate a plurality of first-level volume elements for inclusion in the workpiece model, each first-level volume element associated with a respective first-level volume in the workspace volume and representing presence of the surface of said workpiece in the respective first-level volume, said first-level volumes being larger than said second-level volumes and each first-level volume containing a set of second-level volumes.

6. The method of claim 5 wherein causing the at least one processor to generate the plurality of first-level volume elements comprises, after causing the at least one processor to identify the plurality of second-level volume elements that each include the surface of the workpiece in an associated second-level volume, for at least one of the identified second-level volumes:
causing the at least one processor to identify a first-level volume containing the second-level volume; and
causing the at least one processor to, in response to said identifying, generate a first-level volume element for inclusion in the workpiece model, said first-level volume element associated with the identified first-level volume and representing presence of the surface of said workpiece in the identified first-level volume.

7. The method of claim 5 further comprising causing the at least one processor to generate at least one further first-level volume element for inclusion in the workpiece model, each of the further first-level volume elements associated with a respective first-level volume in the workspace volume and representing presence of an interior of said workpiece in the respective first-level volume.

8. The method of claim 7 further comprising:
causing the at least one processor to receive signals representing at least one tool volume to be applied to the workpiece, said at least one tool volume including at least one tool envelope; and
causing the at least one processor to update the workpiece model based on the at least one tool volume, said updating the workpiece model comprising:
causing the at least one processor to determine that at least one of the first-level volume elements is a potential partially removed first-level volume element that represents presence of at least a portion of said workpiece in a first-level volume that may be partially within the at least one tool volume;
causing the at least one processor to determine that at least one set of the second-level volume elements is a potential partially removed set of second-level volume elements that is associated with second-level volumes contained within a first-level volume associated with a potential partially removed first-level volume element; and
causing the at least one processor to, in response to determining that at least one set of the second-level volume elements is a potential partially removed set of second-level volume elements, update the potential partially removed set of second-level volume elements.

9. The method of claim 8 wherein causing the at least one processor to determine that at least one of the first-level volume elements is a potential partially removed first-level volume element comprises causing the at least one processor to update the workpiece model to remove tooled first-level volumes, said causing the at least one processor to update the workpiece model to remove tooled first-level volumes comprising, for one or more of the first-level volume elements:
causing the at least one processor to determine that the first-level volume element is a removed first-level volume element that represents presence of at least a portion of said workpiece in a first-level volume that is completely within the at least one tool volume; and
causing the at least one processor to, in response to said determining that the first-level volume element is a removed first-level volume element, update the workpiece model to represent absence of the workpiece in the first-level volume that is completely within the at least one tool volume.

10. The method of claim 9 wherein causing the at least one processor to update the workpiece model to remove tooled first-level volumes comprises causing the at least one processor to determine that a center of the first-level volume associated with the removed first-level volume element is within the at least one tool volume and more than a first-level threshold distance from the at least one envelope of the at least one tool volume.

11. The method of claim 9 wherein causing the at least one processor to determine that the potential partially removed first-level volume element represents presence of at least a portion of the workpiece in a first-level volume that may be partially within the at least one tool volume comprises, after causing the at least one processor to update the workpiece model to remove tooled first-level volumes, causing the at least one processor to apply at least one criterion to the first-level volume associated with the potential partially removed first-level volume element to determine that the first-level volume may be partially within the at least one tool volume.

12. The method of claim 11 wherein causing the at least one processor to apply the at least one criterion to the first-level volume comprises causing the at least one processor to determine that a center of the first-level volume is within a first-level threshold distance from the at least one envelope of the at least one tool volume.

13. The method of claim 8 wherein causing the at least one processor to update the potential partially removed set of second level volume elements comprises, for one or more second-level volume elements of the potential partially removed set of second-level volume elements:
causing the at least one processor to determine that the second-level volume element is a partially removed second-level volume element that represents presence of at least a portion of the workpiece model in a second-level volume that is partially within the at least one tool volume; and
causing the at least one processor to, in response to determining that the second-level volume element is a partially removed second-level volume element, update the workpiece model to represent presence of a surface of the workpiece in the second-level volume associated with the partially removed second-level volume element.

14. The method of claim 13 wherein causing the at least one processor to determine that the second-level volume element is a partially removed second-level volume comprises, causing the at least one processor to update the workpiece model to remove tooled second-level volumes, said causing the at least one processor to update comprising for one or more of the second-level volume elements:
causing the at least one processor to determine that the second-level volume element is a removed second-level volume element that represents presence of at least a portion of said workpiece in a second-level volume that is completely within the at least one tool volume; and
causing the at least one processor to, in response to determining that the second-level volume element is a removed second-level volume element, update the workpiece model to represent absence of the workpiece in the second-level volume that is completely within the at least one tool volume.

15. The method of claim 14 wherein causing the at least one processor to determine that the second-level volume element represents a second-level volume that is partially within the at least one tool volume comprises, after said updating the workpiece model to remove tooled second-level volumes, causing the at least one processor to apply at least one criterion to the second-level volume associated with the second-level volume element to determine that the second-level volume is partially within the at least one tool volume.

16. The method of claim 15 wherein causing the at least one processor to apply the at least one criterion to the second-level volume comprises causing the at least one processor to determine that a center of the second-level volume is within a second-level threshold distance from the at least one envelope of the at least one tool volume and that a first boundary vertex of the second-level volume is within the at least one envelope and a second boundary vertex of the second-level volume is outside of the at least one envelope.

17. The method of claim 13 wherein causing the at least one processor to update the potential partially removed set of second-level volume elements comprises causing the at least one processor to update the boundary surface elements, said causing the at least one processor to update the boundary surface elements comprising, for one or more sets of boundary surface elements:
causing the at least one processor to determine that the set of boundary surface elements is associated with a second-level volume that is associated with a partially removed second-level volume element; and
causing the at least one processor to, in response to determining that the set of boundary surface elements is associated with a second-level volume that is associated with a partially removed second-level volume element, updating the set of boundary surface elements based at least in part on the at least one tool volume.

18. A computer-implemented method of geometric simulation for manufacturing operations, the method comprising:
causing at least one processor to receive signals representing a workpiece to be machined in a workspace volume;
causing the at least one processor to derive, based on said signals representing the workpiece, a workpiece model representing the workpiece, said workpiece model including:
a plurality of first-level volume elements, each representing presence of at least a portion of said workpiece in a respective first-level volume within the workspace volume;
a plurality of sets of second-level volume elements, each set of second-level volume elements:
associated with a respective one of the first-level volumes; and
including one or more second-level volume elements, each representing presence of at least a portion of said workpiece in a respective second-level volume within said one of the first-level volumes, wherein said second-level volume is smaller than said first-level volume;
causing the at least one processor to receive signals representing at least one tool volume to be applied to the workpiece, said at least one tool volume including at least one tool envelope; and
causing the at least one processor to update the workpiece model based on the at least one tool volume, said updating the workpiece model comprising:
causing the at least one processor to determine that at least one of the first-level volume elements is a potential partially removed first-level volume element that represents presence of at least a portion of said workpiece in a first-level volume that may be partially within the at least one tool volume;
causing the at least one processor to determine that at least one set of the second-level volume elements is a potential partially removed set of second-level volume elements that is associated with second-level volumes contained within a first-level volume associated with a potential partially removed first-level volume element; and
in response to determining that at least one set of the second-level volume elements is a potential partially removed set of second-level volume elements, causing the at least one processor to update the potential partially removed set of second-level volume elements.

19. The method of claim 18 wherein causing the at least one processor to determine that at least one of the first-level volume elements is a potential partially removed first-level volume element comprises causing the at least one processor to update the workpiece model to remove tooled first-level volumes, said updating comprising, for one or more of the first-level volume elements:
causing the at least one processor to determine that the first-level volume element is a removed first-level volume element that represents presence of at least a portion of said workpiece in a first-level volume that is completely within the at least one tool volume; and
causing the at least one processor to, in response to determining that the first-level volume element is a removed first-level volume element, update the workpiece model to represent absence of the workpiece in the first-level volume that is completely within the at least one tool volume.

20. The method of claim 19 wherein causing the at least one processor to update the workpiece model to remove tooled first-level volumes comprises causing the at least one processor to determine that a center of the first-level volume associated with the removed first-level volume element is within the at least one tool volume and more than a first-level threshold distance from the at least one envelope of the at least one tool volume.

21. The method of claim 19 wherein causing the at least one processor to determine that the potential partially removed first-level volume element represents presence of at least a portion of the workpiece in a first-level volume that may be partially within the at least one tool volume comprises, after causing the at least one processor to update the workpiece model to remove tooled first-level volumes, causing the at least one processor to apply at least one criterion to the first-level volume associated with the potential partially removed first-level volume element to determine that the first-level volume may be partially within the at least one tool volume.

22. The method of claim 21 wherein causing the at least one processor to apply the at least one criterion to the first-level volume comprises causing the at least one processor to determine that a center of the first-level volume is within a first-level threshold distance from the at least one envelope of the at least one tool volume.

23. The method of claim 18 wherein causing the at least one processor to update the potential partially removed set of second level volume elements comprises, for one or more second-level volume elements of the potential partially removed set of second-level volume elements:
causing the at least one processor to determine that the second-level volume element is a partially removed second-level volume element that represents presence of at least a portion of the workpiece model in a second-level volume that is partially within the at least one tool volume; and
causing the at least one processor to, in response to determining that the second-level volume element is a partially removed second-level volume element, update the workpiece model to represent presence of a surface of the workpiece in the second-level volume associated with the partially removed second-level volume element.

24. The method of claim 23 wherein causing the at least one processor to determine that the second-level volume element is a partially removed second-level volume comprises causing the at least one processor to update the workpiece model to remove tooled second-level volumes, said causing the at least one processor to update comprising for one or more of the second-level volume elements:
causing the at least one processor to determine that the second-level volume element is a removed second-level volume element that represents presence of at least a portion of said workpiece in a second-level volume that is completely within the at least one tool volume; and
causing the at least one processor to, in response to said determining, update the workpiece model to represent absence of the workpiece in the second-level volume that is completely within the at least one tool volume.

25. The method of claim 24 wherein causing the at least one processor to determine that the second-level volume element represents a second-level volume that is partially within the at least one tool volume comprises, after causing the at least one processor to update the workpiece model to remove tooled second-level volumes, causing the at least one processor to apply at least one criterion to the second-level volume associated with the second-level volume element to determine that the second-level volume is partially within the at least one tool volume.

26. The method of claim 25 wherein causing the at least one processor to apply the at least one criterion to the second-level volume comprises causing the at least one processor to determine that a center of the second-level volume is within a second-level threshold distance from the at least one envelope of the at least one tool volume and that a first boundary vertex of the second-level volume is within the at least one envelope and a second boundary vertex of the second-level volume is outside of the at least one envelope.

27. The method of claim 23 wherein causing the at least one processor to update the potential partially removed set of second-level volume elements comprises causing the at least one processor to update the boundary surface elements, said causing the at least one processor to update the boundary surface elements comprising, for one or more sets of boundary surface elements:
causing the at least one processor to determine that the set of boundary surface elements is associated with a second-level volume that is associated with a partially removed second-level volume element; and
causing the at least one processor to, in response to determining that the set of boundary surface elements is associated with a second-level volume that is associated with a partially removed second-level volume element, update the set of boundary surface elements based at least in part on the at least one tool volume.

28. A computer-implemented system for geometric modeling to facilitate simulation for manufacturing operations, the system comprising at least one processor configured to:
receive signals representing a workpiece in a workspace volume; and
derive, based on said signals representing the workpiece, a workpiece model representation of the workpiece, said deriving comprising:
identifying a plurality of volumes in the workspace volume that each include a surface of the workpiece;
generating a plurality of volume elements for inclusion in the workpiece model, each volume element associated with a respective identified volume in the workspace volume and representing presence of the surface of said workpiece in the respective identified volume;
for each of the volume elements:
for at least one linear boundary of a set of linear boundaries of the volume associated with the volume element:
determining at least one location on the linear boundary where the surface of said workpiece intersects the linear boundary; and
in response to said determining, generating at least one boundary surface element associated with the volume element for inclusion in the workpiece model, the at least one boundary surface element associated with the linear boundary and representing at least one location at which the surface of said workpiece model intersects the linear boundary;
wherein for at least one of the volume elements:
for at least one linear boundary of a set of linear boundaries of the volume associated with the volume element:
determining said at least one location on the linear boundary where the surface of said workpiece intersects the linear boundary comprises determining first and second different locations on the linear boundary where the surface of said workpiece intersects the linear boundary; and
generating the at least one boundary surface element associated with the volume element comprises generating first and second boundary surface elements that represent the first and second different locations on the linear boundary where the surface of said workpiece intersects the linear boundary.

29-31. (canceled)

32. A computer-implemented system for geometric modeling to facilitate simulation for manufacturing operations, the system comprising at least one processor configured to:
receive signals representing a workpiece to be machined in a workspace volume;
derive, based on said signals representing the workpiece, a workpiece model representing the workpiece, said workpiece model including:
a plurality of first-level volume elements, each representing presence of at least a portion of said workpiece in a respective first-level volume within the workspace volume;
a plurality of sets of second-level volume elements, each set of second-level volume elements:
associated with a respective one of the first-level volumes; and
including one or more second-level volume elements, each representing presence of at least a portion of said workpiece in a respective second-level volume within said one of the first-level volumes, wherein said second-level volume is smaller than said first-level volume;
receive signals representing at least one tool volume to be applied to the workpiece, said at least one tool volume including at least one tool envelope; and
update the workpiece model based on the at least one tool volume, said updating the workpiece model comprising:
determining that at least one of the first-level volume elements is a potential partially removed first-level volume element that represents presence of at least a portion of said workpiece in a first-level volume that may be partially within the at least one tool volume;
determining that at least one set of the second-level volume elements is a potential partially removed set of second-level volume elements that is associated with second-level volumes contained within a first-level volume associated with a potential partially removed first-level volume element; and
in response to determining that at least one set of the second-level volume elements is a potential partially removed set of second-level volume elements, causing the at least one processor to update the potential partially removed set of second-level volume elements.
